(19) United States
(12) Patent Application Publication
(10) Pub. No.: US 2010/0332563 A1
(43) Pub. Date: Dec. 30, 2010

(54) INFORMATION PROCESSING APPARATUS, INFORMATION PROCESSING METHOD, AND RECORDING MEDIUM

(75) Inventor: Yoshiaki FUJIKAWA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/815,977

(22) Filed: Jun. 15, 2010

(30) Foreign Application Priority Data
Jun. 26, 2009 (JP) 2009-152764

(51) Int. Cl. G06F 17/30

(52) U.S. Cl. 707/813; 707/E17.005

(57) ABSTRACT

An information processing apparatus includes, a file output detector configured to detect a request for performing a process of outputting a file from a first storage medium, and a program addition processing unit configured to add a data deleting program to the file to be output when the file output detector detects the request for performing the process of outputting a file, wherein the data deleting program causes an apparatus which received the file to perform a method, the method including determining whether a preset period of time has been elapsed, and deleting at least part of data of the file when it is determined that the preset period of time has been elapsed.

### CROSS-REFERENCE TO RELATED APPLICATIONS

This application is based upon and claims the benefit of priority of the prior Japanese Patent Application No. 2009-152764, filed on Jun. 26, 2009, the entire contents of which are incorporated herein by reference.

### BACKGROUND

In recent years, there has been a problem in that data including important information such as personal information and company's confidential information has been unintentionally distributed through a network or a portable recording medium. For example, when important data used by company members is copied in a portable storage medium or a laptop PC (Personal Computer), the company members should remove the copied data after using the data. However, a user may lose the portable storage medium and the laptop PC, or the portable storage medium and the laptop PC may be stolen. In this case, if the important data which has been copied is not removed, the data may be leaked to third parties.

In order to prevent such leakage, a program used to prevent the PC to be used when the PC is lost or stolen has been proposed. In addition, a system capable of chasing a position of the PC using the GPS (Global Positioning System) has been proposed.

Furthermore, a technique of enabling data to be used only in a predetermined period of time when the data is copied in another computer has been proposed. For example, a system which determines a period of time in which a file received from a transmitter may be opened with reference to a relative time recognized by the transmitter and a receiver through a process of an application performed by a computer of the receiver has been proposed (Japanese Unexamined Patent Application Publication No. 2005-316903, for example).

Note that as a management server which integrally manages data, a management server which updates, when an access right including a validity period is assigned to data which is required to be downloaded by a client and upload of the data is requested within the validity period, the access right assigned to the data has been proposed (Japanese Unexamined Patent Application Publication 1999-345179, for example).

Furthermore, as a technique of deleting data, a technique of replacing a NULL packet which may be deleted among packets included in a transport stream of a broadcasting channel by data having a number of bits the same as that of the NULL packet has been proposed (Japanese Unexamined Patent Application Publication No. 2004-247881, for example).

### SUMMARY

According to an aspect of the invention, an information processing apparatus includes, a file output detector configured to detect a request for performing a process of outputting a file from a first storage medium and a program addition processing unit configured to add a data deleting program to the file to be output when the file output detector detects the request for performing the process of outputting a file, wherein the data deleting program causes an apparatus which received the file to perform a method, the method including the operations of determining whether a preset period of time has been elapsed, and deleting at least part of data of the file when it is determined that the preset period of time has been elapsed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

The above-described embodiments of the present invention are intended as examples, and all embodiments of the present invention are not limited to including the features described above.

### BRIEF DESCRIPTION OF THE DRAWINGS

FIG. 1 is a diagram illustrating a configuration example of an information processing system according to a first embodiment;

FIG. 2 is a diagram illustrating a system configuration of an information processing system according to a second embodiment;

FIG. 3 is a diagram illustrating an example of a hardware configuration of a PC of a transmitter;

FIG. 4 is a block diagram illustrating functions of the PC of the transmitter;

FIG. 5 is a diagram illustrating an example of information registered in a database;

FIG. 6 is a flowchart illustrating a procedure of a process performed by the PC of the transmitter when copy of data is requested;

FIG. 7 is the flowchart illustrating the procedure of the process performed by the PC of the transmitter when the copy of data is requested;

FIG. 8 is a block diagram illustrating functions of a PC of a receiver when a file is supplied through a network;

FIG. 9 is a flowchart illustrating a procedure of a process performed by the PC of the receiver when a data deleting program included in the file supplied through the network is first executed;

FIG. 10 is the flowchart illustrating the procedure of the process performed by the PC of the receiver when the data deleting program included in the file supplied through the network is first executed;

FIG. 11 is a flowchart illustrating a procedure of a process performed by the PC of the receiver when the data deleting program is executed after activation;

FIG. 12 is the flowchart illustrating the procedure of the process performed by the PC of the receiver when the data deleting program is executed after activation;

FIG. 13 is a block diagram illustrating functions of the PC of the receiver when a file is supplied through a portable storage medium;

FIG. 14 is a flowchart illustrating a procedure of a process performed by the PC of the receiver when a data deleting program included in the file supplied through the portable storage medium is first executed;

FIG. 15 is the flowchart illustrating the procedure of the process performed by the PC of the receiver when the data deleting program included in the file supplied through the portable storage medium is first executed;

FIG. 16 is a block diagram illustrating functions of the PC of the transmitter;

FIG. 17 is a flowchart illustrating a procedure of a process performed by the PC of the transmitter when a copy of data is requested;

FIG. 18 is the flowchart illustrating the procedure of the process performed by the PC of the transmitter when the copy of data is requested;

FIG. 19 is a block diagram illustrating functions of the PC of the receiver when a file is copied through the network;

FIG. 20 is a flowchart illustrating a procedure of an initial process performed by the PC of the receiver when the file is copied through the network;

FIG. 21 is a block diagram illustrating functions of the PC of the receiver when a file is supplied through a portable storage medium; and

FIG. 22 is a flowchart illustrating a procedure of an initial process performed by the PC of the receiver when the file is supplied through the portable storage medium.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

Hereinafter, embodiments will be described with reference to the accompanying drawings.

### First Embodiment

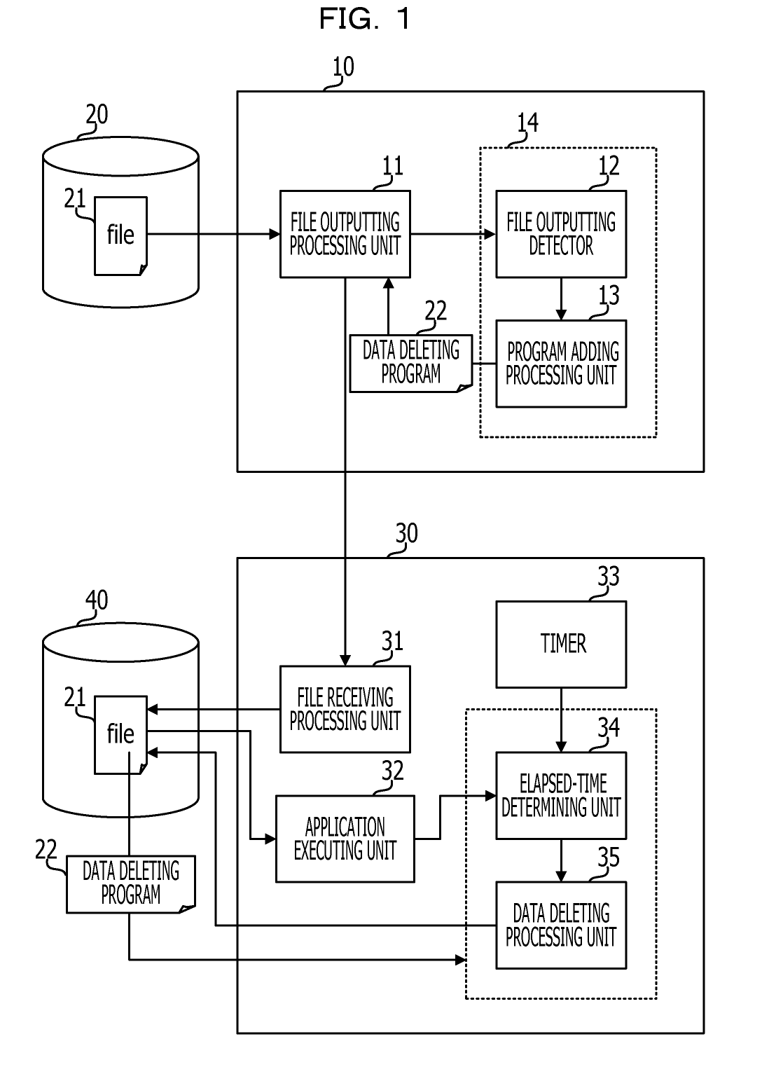

FIG. 1 is a diagram illustrating a configuration example of an information processing system according to a first embodiment

In the information processing system shown in FIG. 1, a file 21 stored in a storage medium 20 connected to an information processing apparatus 10 is supplied to another information processing apparatus 30. The information processing apparatuses 10 and 30 are realized as computers, for example.

The file 21 stored in the storage medium 20 is supplied to the information processing apparatus 30 by being output to another storage medium 40 through a process performed by the information processing apparatus 10. In the example shown in FIG. 1, the file 21 is transmitted from the information processing apparatus 10 to the information processing apparatus 30 through a network so as to be output to the storage medium 40 connected to the information processing apparatus 30.

Note that, as described hereinafter, the storage medium 40 serving as an output destination may be a portable storage medium. In this case, after the file 21 is output to the portable storage medium installed in the information processing apparatus 10, the portable storage medium is removed and is inserted into the information processing apparatus 30. In this way, the file 21 is supplied to the information processing apparatus 30.

In order to supply the file 21 to the information processing apparatus 30 through the network, as shown in FIG. 1, the information processing apparatus 10 includes a file outputting processing unit 11, a file outputting detector 12, and a program adding processing unit 13 as functions associated with a process for outputting the file 21.

The file outputting processing unit 11 performs a process of outputting the file 21 to the storage medium 40 in accordance with a user's operation input, for example. In this example, the file 21 is transmitted to the information processing apparatus 30 and stored in the storage medium 40. Note that as a process of transmitting the file 21, for example, a process of copying the file 21 included in the storage medium 20 in a storage region included in the information processing apparatus 30 may be employed. Furthermore, a process of transmitting the file 21 attached to an electronic mail to the information processing apparatus 30 may be employed. Moreover, a process of removing the file 21 from the storage medium 20 and transmitting the file 21 to the information processing apparatus 30 may be employed. This process is referred to as a “cut-and-paste process”.

Note that, when the copy process or the cut-and-paste process of the file 21 is performed, the file outputting processing unit 11 is realized as part of a function of managing directories of files stored in the storage medium 20 connected to the information processing apparatus 10 and accesses to the files, that is, a file managing function, for example. The file managing function is one of functions realized when the information processing apparatus 10 executes an OS (Operating System) program. Furthermore, when the file 21 added to an electronic mail is to be transmitted, the file outputting processing unit 11 is realized when the information processing apparatus 10 executes an electronic mail transmitting program, for example.

The file outputting detector 12 determines whether the process of outputting the file 21 to the storage medium 40 performed by the file outputting processing unit 11 is requested in accordance with a user's operation, for example. This detecting process is performed by monitoring operation of the file outputting processing unit 11. When detecting the request for performing the process of outputting the file 21, the file outputting detector 12 notifies the program adding processing unit 13 of the request.

The program adding processing unit 13 adds a data deleting program 22 to the file 21 to be output to the storage medium 40 under control of the file outputting processing unit 11 in response to the notification supplied from the file outputting detector 12. By this, the file outputting processing unit 11 transmits the file 21 to which the data deleting program 22 is added to the information processing apparatus 30. Note that the data deleting program 22 is embedded in a header region of the file 21, for example. Alternatively, the data deleting program 22 may be transmitted as a file which is different from the file 21 and which is associated with the file 21.

The data deleting program 22 is executed by the information processing apparatus 30 serving as a transmission destination of the file 21. When the data deleting program 22 is executed, the information processing apparatus 30 can normally use the file 21 only in a predetermined period of time. Accordingly, it is unlikely that the file 21 is illegally used, and security of the file 21 is enhanced.

Note that the program adding processing unit 13 may embed a time point when the file 21 is output in the data deleting program 22. Furthermore, this time point is preferably measured by the information processing apparatus 30. By this, when the data deleting program 22 is executed by the information processing apparatus 30, a period of time elapsed after the file 21 is output can be accurately detected.

Note that the functions of the file outputting detector 12 and the program adding processing unit 13 are realized when the information processing apparatus 10 executes a data managing program 14, for example. Furthermore, the function of the file outputting processing unit 11 may be part of a function realized when the data managing program 14 is executed.

Furthermore, when the file outputting detector 12 detects a request for performing the process of outputting the file 21, an output determining unit, not shown, may determine whether an output destination is permitted as an output destination of the file 21. The output determining unit performs the determining process with reference to a database, not shown. Then, when a transmission is not permitted, the output determining unit prohibits the file outputting processing unit 11 from outputting the file 21. On the other hand, an output of the file 21 is permitted, information on the permission is transmitted to the program adding processing unit 13, and the process is performed by the program adding processing unit 13 as described above. By this, the file 21 is prevented from being output to a destination which has not been permitted, and accordingly, the security of the file 21 is further enhanced.

The information processing apparatus 30 includes a file receiving processing unit 31, an application executing unit 32, a timer 33, an elapsed-time determining unit 34, and a data deleting processing unit 35 as functions of processing the file 21 supplied from the information processing apparatus 10. Among these units, the file receiving processing unit 31, the application executing unit 32, and the timer 33 are included in the information processing apparatus 30 in advance. Furthermore, the elapsed-time determining unit 34 and the data deleting processing unit 35 are realized when the data deleting program 22 which is added to the file 21 and which is transmitted from the information processing apparatus 10 is executed.

The file receiving processing unit 31 stores the file 21 which includes the data deleting program 22 added thereto and which is transmitted from the information processing apparatus 10 through the process performed by the file outputting processing unit 11 in the storage medium 40 connected to the information processing apparatus 30. When the process of transmitting the file 21 is performed as a copy process or a cut-and-paste process of the file 21, the file receiving processing unit 31 is realized as a file management function which is one of functions realized when the information processing apparatus 30 executes an OS program. Furthermore, in a case where the file 21 is transmitted by being attached to an electronic mail, the file receiving processing unit 31 is realized when the information processing apparatus 30 executes an electronic-mail receiving program, for example.

The application executing unit 32 is a function realized when the information processing apparatus 30 executes an application program corresponding to the file 21, and performs processing after reading the file 21. This operation is generally referred to as a “file opening operation”.

The timer 33 corresponds to a function of measuring time, and is realized when the OS program is executed.

The data deleting program 22 is executed by the information processing apparatus 30 before the file 21 is read for the first time and processed by the application executing unit 32 at the latest. For example, the data deleting program 22 is executed before the file 21 is read, when a request for processing the file 21 by the application executing unit 32 is supplied in accordance with a user's operation input after the file 21 to which the data deleting program 22 is added is received. Alternatively, the data deleting program 22 may be automatically executed when the information processing apparatus 30 received the file 21. The elapsed-time determining unit 34 and the data deleting processing unit 35 are realized when the data deleting program 22 is executed.

The elapsed-time determining unit 34 obtains a current time from the timer 33. Then, the elapsed-time determining unit 34 determines whether a preset period of time has been elapsed with reference to a time point when the file 21 is output from the information processing apparatus 10. This preset period of time may be arbitrarily determined by the information processing apparatus 10 before the file 21 is output.

When the elapsed-time determining unit 34 determined that the preset period of time has been elapsed, the data deleting processing unit 35 executes a process of deleting the file 21. In this deleting process, for example, at least part of data bits of the file 21 is replaced by other values so that the file 21 is not to be processed by the application executing unit 32 in an original state. For example, a process of replacing data of the file 21 by “0” may be employed. Furthermore, the file 21 itself may be removed by this deleting process.

The data of the file 21 supplied to the information processing apparatus 30 is deleted after a certain period of time through processes performed by the elapsed-time determining unit 34 and the data deleting processing unit 35. By this, even when the user loses the information processing apparatus 30 to which the storage medium 40 is connected or the information processing apparatus 30 is stolen, it is unlikely that the file 21 is illegally used. Furthermore, a situation in which the user forgets to remove the file 21 and therefore the file 21 is illegally used can be avoided. Accordingly, the security of the file 21 is further enhanced.

Furthermore, even when the information processing apparatus 10 is illegally accessed and the file 21 included in the storage medium 20 is illegally read using another computer, for example, the process of deleting the data of the file 21 is executed after the certain period of time has elapsed in the computer. Accordingly, disadvantage caused by leakage of the file 21 is prevented.

Note that, in this embodiment, the case where the file 21 is transmitted to the information processing apparatus 30 is described. However, as another case, for example, the data deleting program 22 may be added to the file 21 when the file 21 is output from the information processing apparatus 10 to a portable storage medium. In this case, after the portable storage medium is removed from the information processing apparatus 10 and installed in another computer, the data deleting program 22 is executed by the computer.

In this case, a basic function realized by executing a data deleting program may be the same as that of the data deleting program 22. However, a starting point of a period of time elapsed by the data of the file 21 is deleted corresponds to a time point when the file 21 is output from the information processing apparatus 10 to the portable storage medium. That is, in the computer to which the portable storage medium has been installed, the data deleting program 22 is performed before an application executing unit included in the computer processes the file 21 at the latest. Then, it is determined whether the preset period of time has been elapsed after the file 21 is output to the portable storage medium. When the determination is affirmative, the process of deleting the file 21 is performed.

Next, a system including apparatuses corresponding to the information processing apparatuses 10 and 30 described above will be described in detail.

### Second Embodiment

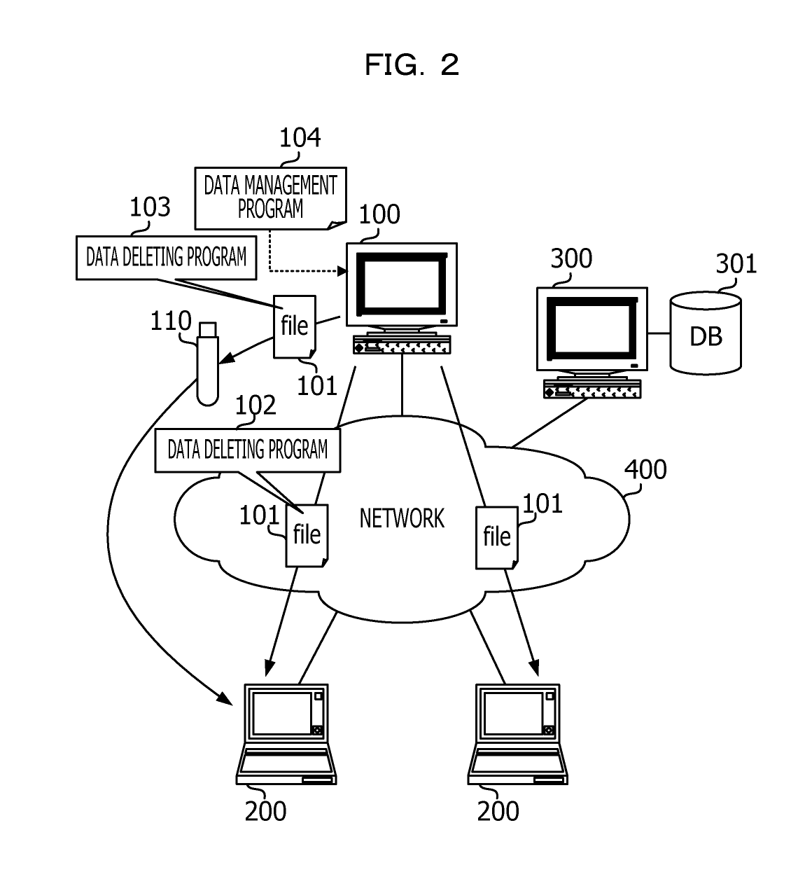

FIG. 2 is a diagram illustrating a system configuration of an information processing system according to a second embodiment.

In the information processing system shown in FIG. 2, a file 101 is supplied from a transmitter PC 100 to a receiver PC 200. In FIG. 2, two receiver PCs 200 are shown as examples. The PCs 100 and 200 are connected to each other through a network 400. Furthermore, a database (DB) server 300 is connected to the network 400. The DB server 300 includes a database 301 in a storage region thereof.

The transmitter PC 100 has a function of transmitting the file 101 stored in a storage region thereof to the receiver PC 200 through the network 400. For example, the file 101 is copied in a storage medium connected to the receiver PC 200. Alternatively, after the file 101 is added to an electronic mail, the file 101 may be transmitted to the receiver PC 200 through an electronic mail server, not shown. Furthermore, the transmitter PC 100 may copy the file 101 to a portable storage medium 110 so that the file 101 is supplied to the receiver PC 200.

Note that, instead of the copy of the file 101, a cut-and-paste process may be performed so that the file 101 is removed from an original storage region and recorded in another storage region. Note that, in this embodiment and embodiments described below, only a process of copying the file 101 will be described for simplicity of description. The process of copying the file 101 may be replaced by the cut-and-paste process where appropriate.

When the file 101 is to be transmitted through the network 400 or when the file 101 is to be recorded in the portable storage medium 110, the PC 100 adds a data deleting program to the file 101. When the file 101 is to be supplied through the network 400, a data deleting program 102 for a network transmission is added to the file 101. On the other hand, when the file 101 is to be copied in the portable storage medium 110, a data deleting program 103 for a portable storage medium 110 is added to the file 101.

When the data deleting program 102 or 103 is executed in an apparatus serving as a transmission destination (for example, the PC 200), content of the supplied file 101 is automatically deleted after a certain period of time. By this, a possibility for illegal use of the supplied file 101 is reduced, and security of the file 101 is enhanced.

In the PC 100, a function of adding the data deleting program 102 or 103 is realized when a data management program 104 is executed. Furthermore, when the file 101 is to be transmitted through the network 400, it is determined whether a transmission of the file 101 to a transmission destination is permitted. When the determination is negative, a process of transmitting the file 101 is not executed. That is, the file 101 is not transmitted to a transmission destination of low security. Consequently, the security of the file 101 is further enhanced. Furthermore, the file 101 may be transmitted to a specific transmission destination without adding the data deleting program 102 to the file 101. A function of determining whether such a transmission is to be performed and a function of determining whether a program is to be added are also realized when the data management program 104 is executed.

Note that the database 301 may be stored in an NAS (Network Attached Storage) connected to the network 400, for example. Furthermore, the database 301 may be stored in a storage region included in the PC 100.

Furthermore, a file server may be employed as a transmitter apparatus, for example. In this case, the file server copies a file managed therein to a receiver apparatus in response to a request transmitted from the receiver apparatus (e.g., the PC 200). Note that, when the file server is employed, a function of transmitting a file using an electronic mail or a portable storage medium is not basically provided.

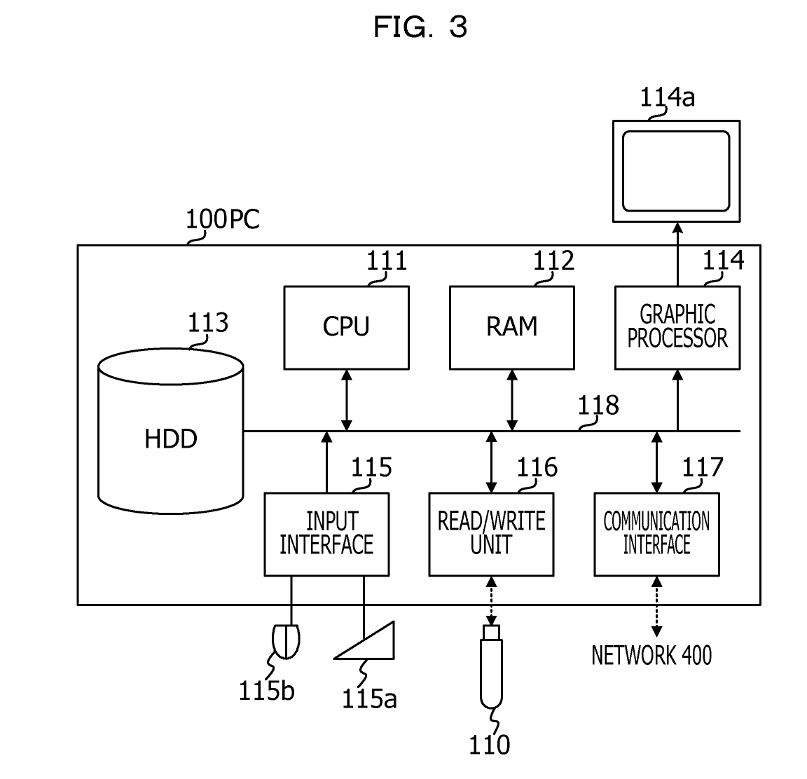

FIG. 3 is a diagram illustrating an example of a hardware configuration of the transmitter PC 100.

The transmitter PC 100 includes a CPU (Central Processing Unit) 111, a RAM (Random Access Memory) 112, an HDD (Hard Disk Drive) 113, a graphic processor 114, an input interface (I/F) 115, a read/write unit 116, and a communication interface (IF) 117 which are connected to one another through a bus 118.

The CPU 111 integrally controls the entire PC 100 by executing various programs stored in a storage medium such as the HDD 113. The RAM 112 temporarily stores at least some of programs to be executed by the CPU 111 and various data used for processes performed in accordance with the programs. The HDD 113 stores programs to be executed by the CPU 111 and various data required for executions of the programs.

The graphic processor 114 is connected to a monitor 114a, for example. The graphic processor 114 displays an image in a screen of the monitor 114a in accordance with an instruction issued by the CPU 111. The input interface 115 is connected to a keyboard 115a and a mouse 115b, for example. The input interface 115 transmits a signal supplied from the keyboard 115a or the mouse 115b to the CPU 111 through the bus 118.

The read/write unit 116 writes data supplied from the CPU 111 through the bus 118 in the portable storage medium 110. Furthermore, the read/write unit 116 reads data from the portable storage medium 110 and transmits the read data to the CPU 111 through the bus 118. Note that examples of the portable storage medium 110 include an optical disc, a flexible disk, and a semiconductor memory connected through a USB (Universal Serial Bus) interface or the like.

The communication interface 117 performs data transmission/reception with an external apparatus such as the PC 200 or the DB server 300 through the network 400.

Note that the reception PC 200 and the DB server 300 may be realized with hardware configurations the same as that of the PC 100 shown in FIG. 3.

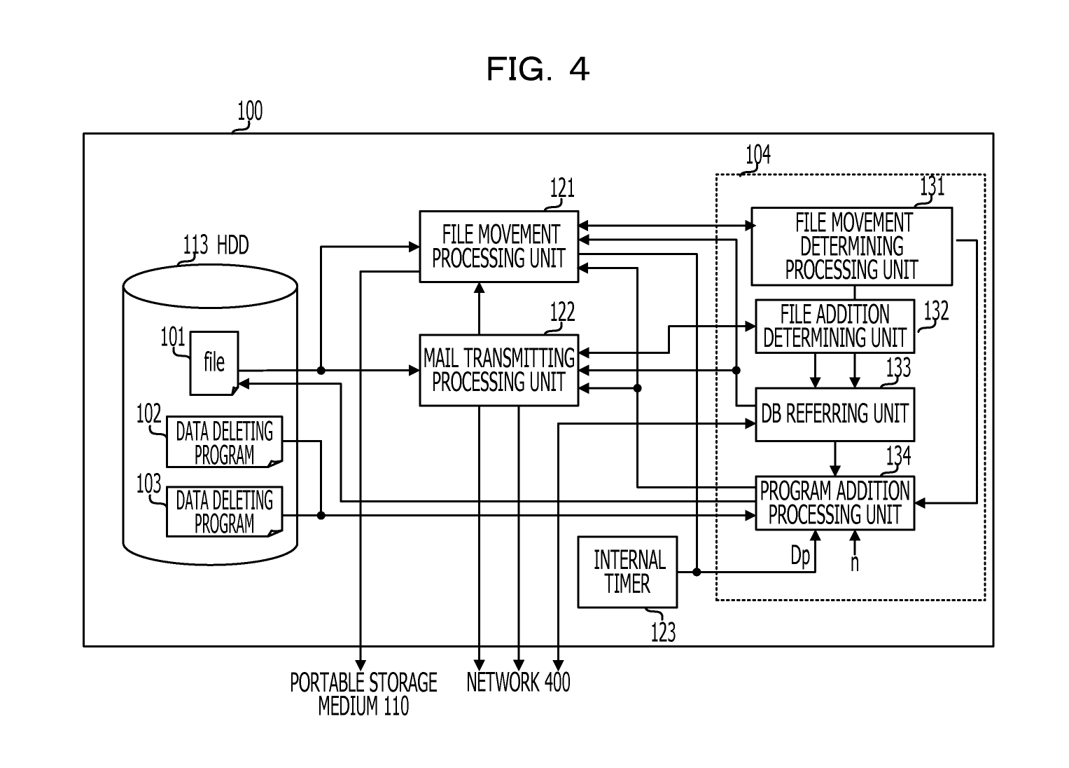

FIG. 4 is a block diagram illustrating functions of the transmitter PC.

The transmitter PC 100 includes a file movement processing unit 121, a mail transmitting processing unit 122, and an internal timer 123.

The file movement processing unit 121 performs a process of copying the file 101 recorded in the HDD 113 in accordance with a user's operation input using the PC 100 or in accordance with a request supplied through the network 400 from the external apparatus such as the PC 200. A function of the file movement processing unit 121 is realized, for example, as part of a file managing function which is one of functions realized when the OS is executed.

The mail transmitting processing unit 122 is a function realized when an application program for transmitting and receiving an electronic mail is executed. The mail transmitting processing unit 122 transmits an electronic mail through the network 400 in accordance with a user's operation input. In this case, an electronic mail to which the file 101 stored in the HDD 113 has been attached may be transmitted. Note that, instead of the function of performing the process of transmitting an electronic mail, a function of performing a process of transmitting an instant message may be employed, for example.

The internal timer 123 is a function of counting a date and time and is realized when the OS is executed.

The PC 100 further includes, as functions realized when the data management program 104 is executed, a file movement determining processing unit 131, a file addition determining unit 132, a database (DB) referring unit 133, and a program addition processing unit 134.

The file movement determining processing unit 131 monitors operation of the file movement processing unit 121 and determines whether a performance of the process of copying the file 101 stored in the HDD 113 is requested. The file addition determining unit 132 monitors operation of the mail transmitting processing unit 122 and determines whether a performance of the process of attaching the file 101 included in the HDD 113 to an electronic mail to be transmitted is requested.

The DB referring unit 133 accesses the DB server 300 so as to refer to the database 301 when the process of transmitting the file 101 to the external apparatus is started. Then, the DB referring unit 133 determines whether a transmission of the file 101 to a current transmission destination is permitted and determines whether the data deleting program 102 is to be added to the file 101 to be transmitted. The DB referring unit 133 further has a function of updating the database 301 in accordance with a user's operation input.

The program addition processing unit 134 adds the data deleting program 102 or 103 to the file 101 copied by the file movement processing unit 121 or the file 101 to be attached to an electronic mail by the mail transmitting processing unit 122. When the file 101 is to be copied in the portable storage medium 110, the data deleting program 103 is added to the file 101, and otherwise the data deleting program 102 is added to the file 101. Furthermore, the data deleting programs 102 and 103 are added to the file 101 by being embedded in a header region of the file 101, for example.

Furthermore, the program addition processing unit 134 embeds a current date and time Dp and a period of time n until the file 101 is deleted in the data deleting programs 102 and 103 to be added. The current date and time Dp is obtained from the internal timer 123. Furthermore, when the file 101 is to be copied to the external apparatus, a date and time counted by the external apparatus may be obtained through the file movement processing unit 121. Although a preset value is used as the period of time n, the program addition processing unit 134 may arbitrarily set a value of the period of time n in accordance with a user's operation input.

Note that, in the functions described above, the function of the file movement processing unit 121 may be realized by executing the data management program 104.

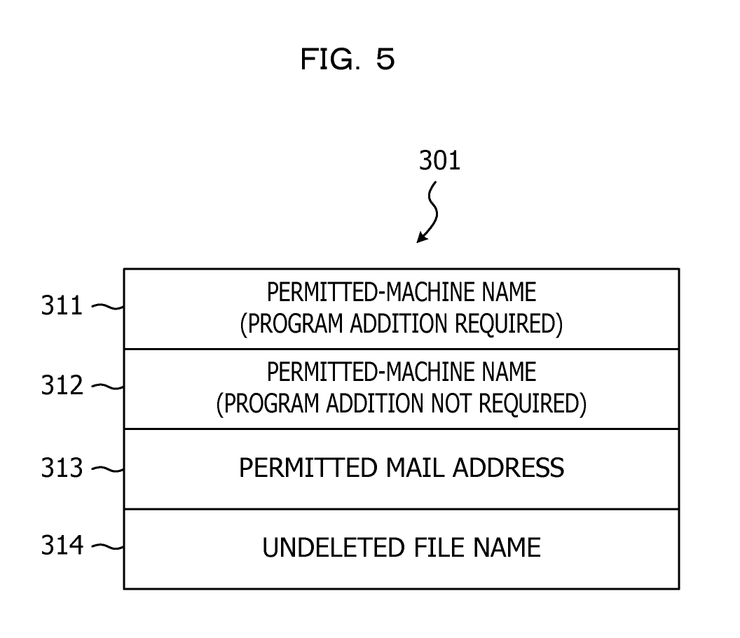

FIG. 5 is a diagram illustrating an example of information registered in the database 301.

In the database 301, names 311 and 312 of permitted machines (hereinafter referred to as “permitted-machine names” 311 and 312), a permitted mail address 313, and a name 314 of a file not to be deleted (hereinafter referred to as a “undeleted file name” 314) are registered.

The permitted-machine name 311 represents a name of an apparatus, among apparatuses connected to the network 400, which is allowed to copy the file 101 on condition that the data deleting program 102 is added to the file 101. The permitted-machine name 312 represents a name of an apparatus, among the apparatuses connected to the network 400, which is allowed to copy the file 101 without adding the data deleting program 102 to the file 101.

Note that as registration information, not only machine names but also information used to identify an apparatus serving as a copy destination may be registered. For example, a network address or a MAC address (Media Access Control) of an apparatus serving as a copy destination may be registered.

Examples of copy destination apparatuses to be registered in the permitted-machine names 311 and 312 include the following apparatuses. A desktop PC, among the apparatuses connected to the network 400, which is installed in a company where a copy source apparatus is installed and which includes the data management program 104 is considered to ensure security of copied data. Therefore, a name of such an apparatus is registered as the permitted-machine name 312. On the other hand, a name of a laptop PC possessed by an employee is registered as the permitted-machine name 311.

The permitted mail address 313 represents a mail address of a transmission destination to which the file 101 attached to an electronic mail is permitted to be transmitted on condition that the data deleting program 102 is added to the file 101. Note that, in addition to the permitted mail address 313, a mail address of a transmission destination to which the file 101 attached to an electronic mail is prohibited from being transmitted or a mail address of a transmission destination to which the file 101 attached to an electronic mail can be transmitted without adding the data deleting program 102 may be registered.

The undeleted file name 314 represents a name of a file 101 which is permitted to be copied to another apparatus or the portable storage medium 110 or which is permitted to be attached to an electronic mail without conditions. Note that, in addition to this, a file name of a file 101 which is not permitted to be copied or which is not permitted to be attached to an electronic mail may be registered.

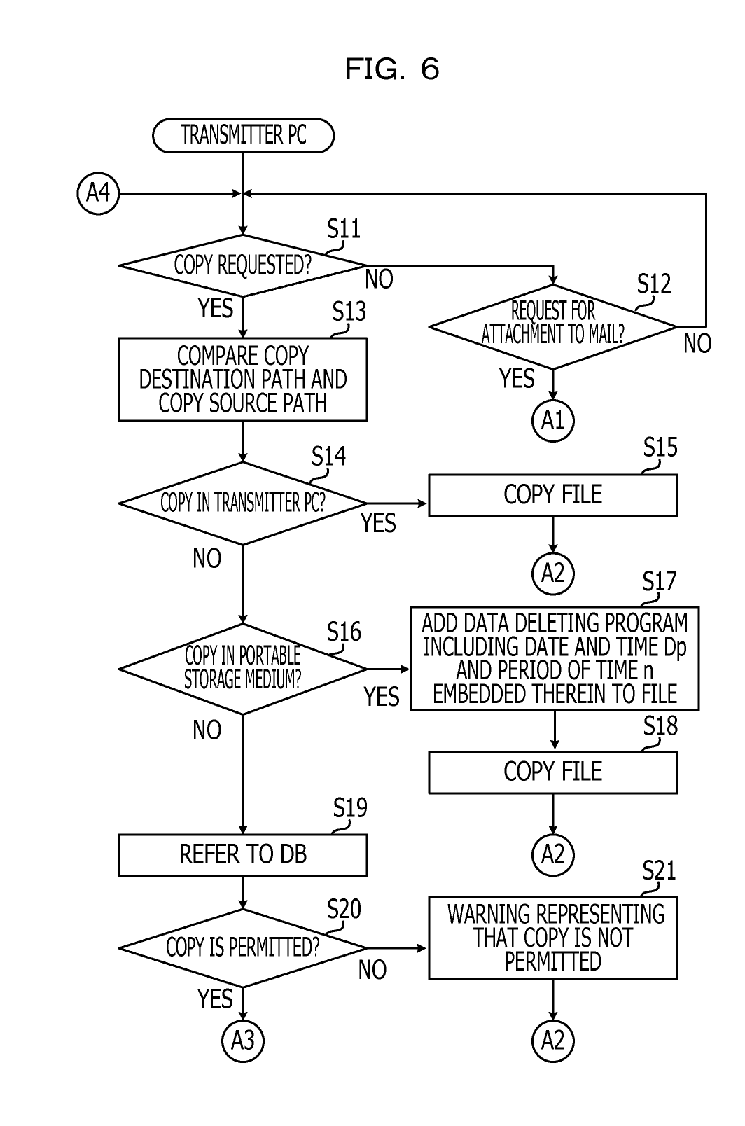

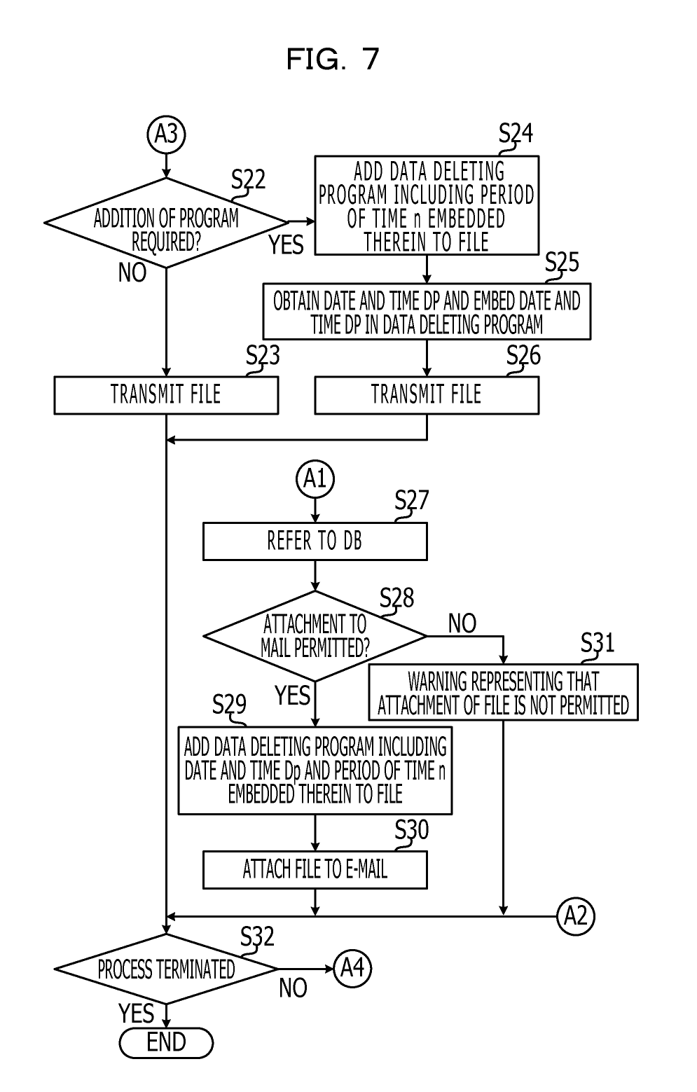

FIGS. 6 and 7 are a flowchart illustrating a procedure of a process performed by the transmitter PC 100 when a copy of data is requested.

In operation S11, the file movement determining processing unit 131 monitors operation of the file movement processing unit 121, and determines whether a copy of the file 101 is requested in accordance with a user's operation input to the PC 100 or an operation request supplied from the PC 200. When the determination is affirmative, a process in operation S13 is performed, whereas when the determination is negative, a process in operation S12 is performed.

In operation S12, the file addition determining unit 132 monitors operation of the mail transmitting processing unit 122 and determines whether a process of attaching the file 101 to an electronic mail is requested in accordance with a user's operation input to the PC 100. When the determination is affirmative, a process in operation S27 is performed, whereas when the determination is negative, the process in operation S11 is performed again.

In operation S13, the file movement determining processing unit 131 obtains a path of a copy destination of the file 101 requested to be copied and a path of a copy source from the file movement processing unit 121 and compares the paths with each other.

In operation S14, the file movement determining processing unit 131 determines whether a copy of the file 101 in the storage region included in the PC 100 is requested in accordance with a result of the comparison of the paths performed in operation S13. For example, in a case where a machine name of the copy destination is the same as that of the PC 100 and a logic volume of the copy destination is the same as that assigned to the HDD 113 which currently stores the file 101, it is determined that a copy of the file 101 in the PC 100 is requested. In this case, a process in operation S15 is executed, and otherwise a process in operation S16 is executed.

In operation S15, the file movement determining processing unit 131 permits the file movement processing unit 121 to copy the file 101. The file movement processing unit 121 copies the file 101 in a requested region included in the HDD 113. Thereafter, a process in operation S32 is performed.

In operation S16, the file movement determining processing unit 131 determines whether a copy of the file 101 in the portable storage medium 110 is requested in accordance with the result of the comparison of the paths performed in operation S13. When the determination is affirmative, a process in operation S17 is executed. On the other hand, when the determination is negative, a process in operation S19 is performed.

In operation 517, the file movement determining processing unit 131 notifies the program addition processing unit 134 of the request for copying the file 101 in the portable storage medium 110. The program addition processing unit 134 obtains a current date and time Dp from the internal timer 123. Furthermore, the program addition processing unit 134 reads the data deleting program 103 for the portable storage medium 110 from the HDD 113, and embeds the date and time Dp and the preset period of time n in the data deleting program 103. Then, the program addition processing unit 134 adds the data deleting program 103 in the file 101. Here, the data deleting program 103 is embedded in the header region of the file 101, for example.

In operation S18, the program addition processing unit 134 permits the file movement processing unit 121 to copy the file 101 to which the data deleting program 103 has been added. The file movement processing unit 121 copies the file 101 to which the data deleting program 103 has been added in the portable storage medium 110. Thereafter, the process in operation S32 is performed.

Note that, although not shown, in the process in operation 517 described above, the file movement determining processing unit 131 may first notify the DB referring unit 133 of a file name of the file 101 and thereafter the DB referring unit 133 may refer to the database 301. Then, when the file name of the file 101 to be copied has been registered as the undeleted file name 314 in the database 301, the file 101 may be copied in the portable storage medium 110 without adding the data deleting program 103 to the file 101.

In operation S19, the file movement determining processing unit 131 determines that a copy of the file 101 to the external apparatus connected to the network 400 has been requested, and notifies the DB referring unit 133 of a machine name assigned to the apparatus serving as a copy destination and a file name of the file 101 to be copied. The DB referring unit 133 accesses the DB server 300 through the network 400 and refers to the database 301.

In operation S20, the DB referring unit 133 reads the permitted-machine names 311 and 312 and the undeleted file name 314 registered in the database 301. Then, the DB referring unit 133 determines whether the machine name serving as the copy destination has been registered as the permitted-machine name 311 or 312 and whether the file name of the file 101 has been registered as the undeleted file name 314. When the machine name of the copy destination has been registered as the permitted-machine name 311 or 312, a process in operation S22 is performed. On the other hand, when the machine name of the copy destination has not been registered as the permitted-machine name 311 nor 312 and the file name of the file 101 has not been registered as the undeleted file name 314, a process in operation S21 is performed.

In operation S21, the DB referring unit 133 requests the file movement processing unit 121 to stop the copy of the file 101, and the file movement processing unit 121 stops performing the process of copying the file 101. Here, when the copy process was requested in accordance with a user's operation using the PC 100, the file movement processing unit 121 displays a warning representing that the copy of the file 101 to the requested copy destination is not permitted through the monitor 114a connected to the PC 100, for example. On the other hand, when the copy process has been requested in accordance with the user's operation input to the copy destination apparatus, the file movement processing unit 121 notifies the copy destination apparatus of information representing that a copy of the file 101 is not permitted. The copy destination apparatus displays a warning representing that the copy of the file 101 is not permitted through a monitor, for example. After the processes described above are performed, the process in operation S32 is performed.

In operation S22, the DB referring unit 133 determines whether the data deleting program 102 is to be added to the file 101 in accordance with the information registered in the database 301. When at least the machine name serving as the copy destination has been registered as the permitted-machine name 312 in the database 301, the DB referring unit 133 determines that the data deleting program 102 is not to be added, and a process in operation S23 is performed. Similarly, when the file name of the file 101 has been registered as the undeleted file name 314, the process in operation S23 is performed. On the other hand, the machine name of the copy destination has been registered as the permitted-machine name 311, the DB referring unit 133 determines that the data deleting program 102 is to be added, and a process in operation S24 is performed.

In operation S23, the DB referring unit 133 permits the file movement processing unit 121 to copy the file 101. The file movement processing unit 121 reads the file 101 from the HDD 113, and transmits the read file 101 to the requested copy destination apparatus. Thereafter, a process in operation S32 is performed.

In operation S24, the DB referring unit 133 notifies the program addition processing unit 134 of a request for copying the file 101 in another apparatus through the network 400. The program addition processing unit 134 reads the data deleting program 102 for the network transmission from the HDD 113, and the preset period of time n is embedded in the data deleting program 102. Then, the data deleting program 102 is added to the file 101. Note that the data deleting program 102 is embedded in the header region of the file 101, for example.

In operation S25, the program addition processing unit 134 permits the file movement processing unit 121 to copy the file 101 to which the data deleting program 102 has been added. Furthermore, the program addition processing unit 134 obtains a current date and time Dp counted by the copy destination apparatus, and embeds the current date and time Dp in the data deleting program 102 which has been added to the file 101. The date and time Dp is obtained, for example, using time point information described in a packet transmitted from the copy destination apparatus when the file movement processing unit 121 communicates with the copy destination apparatus for the copy of the file 101.

Note that, instead of the process in operation S25, a date and time Dp obtained from the internal timer 123 included in the PC 100 may be embedded in the data deleting program 102 in the process in operation S24. However, when the date and time Dp counted by the copy destination apparatus is embedded in the data deleting program 102 in the process in operation S25 as described above, a period of time required for deleting the data in the file 101 which has been copied can be accurately calculated.

In operation S26, the file movement processing unit 121 transmits the file 101 to which the data deleting program 102 has been added to the requested copy destination. Thereafter, the process in operation S32 is performed.

In operation S27, the file addition determining unit 132 obtains an address corresponding to a transmission destination of an electronic mail to which the file 101 is requested to be attached from the mail transmitting processing unit 122, and notifies the DB referring unit 133 of the mail address. The DB referring unit 133 reads the permitted mail address 313 registered in the database 301.

In operation S28, the DB referring unit 133 determines whether an attachment of the file 101 to an electronic mail is permitted in accordance with the information registered in the database 301. When the mail address of the transmission destination has been registered as the permitted mail address 313, a process in operation S29 is performed, and otherwise a process in operation S31 is performed.

In operation S29, the DB referring unit 133 notifies the program addition processing unit 134 of information representing that an attachment of the file 101 to an electronic mail is requested. The program addition processing unit 134 obtains a current date and time Dp from the internal timer 123. Furthermore, the program addition processing unit 134 reads the data deleting program 102 for the network transmission from the HDD 113, and embeds the date and time Dp and the preset period of time n in the data deleting program 102. Then, the data deleting program 102 is added to the file 101. Note that the data deleting program 102 is embedded in the header region of the file 101, for example.

In operation S30, the program addition processing unit 134 permits the mail transmitting processing unit 122 to attach the file 101 to which the data deleting program 102 has been added to an electronic mail. The mail transmitting processing unit 122 attaches the file 101 to which the data deleting program 102 has been added to en electronic mail. Then, the process in operation S32 is performed. Thereafter, the electronic mail to which the file 101 has been attached is transmitted to the network 400 through a process performed by the mail transmitting processing unit 122 at an arbitrary timing.

Note that, although not shown, in the process in operation S29, the DB referring unit 133 notifies the program addition processing unit 134 of the file name of the file 101 to be attached in addition to the mail address of the transmission destination. If the file name of the file 101 to be attached has been registered as the undeleted file name 314 in the database 301, the file 101 may be attached to an electronic mail without adding the data deleting program 102 to the file 101.

In operation S31, the DB referring unit 133 requests the mail transmitting processing unit 122 to stop the process of attaching the file 101. The mail transmitting processing unit 122 stops the process of attaching the file 101. Here, the mail transmitting processing unit 122 displays a warning representing that an attachment of the file 101 is not permitted through the monitor 114a connected to the PC 100, for example. Thereafter, the process in operation S32 is performed.

In operation S32, when an end of the execution of the data management program 104 is not requested by a user's operation or the like, the process in operation S11 is performed again.

According to the processes shown in FIGS. 6 and 7, when a copy of the file 101 to the external apparatus or the portable storage medium 110 is requested, the data deleting program 102 or 103 is basically added to the file 101. Accordingly, the data of the file 101 is deleted after a predetermined period of time from the receiver apparatus. Consequently, security of the file 101 is more enhanced when compared with a case where the user of the receiver apparatus manages the file 101.

Furthermore, since the database 301 is used, the user can arbitrarily set destinations to which the file 101 is not permitted to be transmitted, destinations in which the file 101 is not required to be automatically deleted, and a name of a file not to be deleted. Accordingly, the file 101 is securely prevented from being transmitted to a destination of low security, for example. On the other hand, when security of a transmission destination is high or when a degree of importance of the file 101 requested to be transmitted is low, the file 101 can be transmitted without performing unnecessary processes.

Note that, in the example of the process, a destination which is prohibited or permitted to receive the file 101 and a destination in which the file 101 is not required to be automatically deleted are determined in a unit of an apparatus with reference to the database 301. However, such destinations may be determined in a unit of a storage medium, for example. For example, when a plurality of types of portable storage medium are determined to be output destinations, the determination as to whether a copy of the file 101 is to be permitted may be made in a unit of a type of portable storage medium. Furthermore, for example, a plurality of portable storage media of the same type are determined to be output destinations, the determination as to whether a copy of the file 101 is to be permitted may be made in a unit of an identification number assigned to each of the portable storage media.

Next, a processing function of the receiver PC 200 and operation of the PC 200 will be described. Note that a case where the file 101 is transmitted through the network 400 and a case where the file 101 is transmitted through the portable storage medium 110 are individually described.

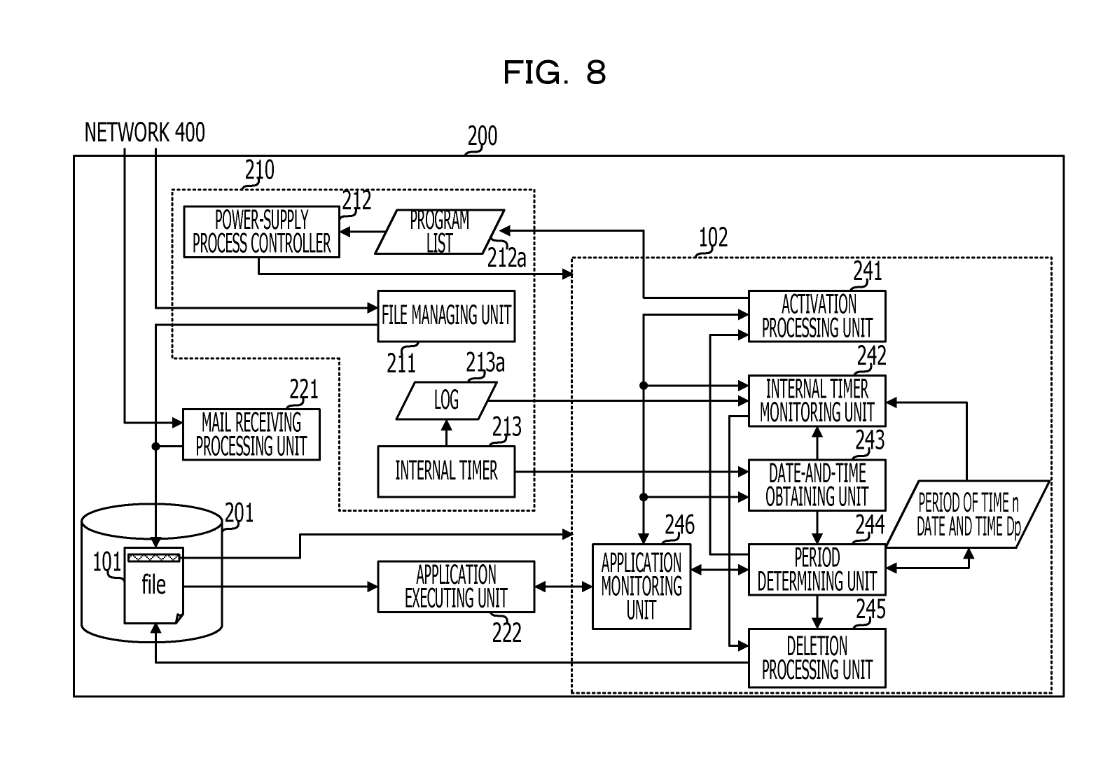

FIG. 8 is a block diagram illustrating functions of the receiver PC 200 when the file 101 is supplied through the network 400.

The receiver PC 200 includes a file managing unit 211, a power-supply process controller 212, an internal timer 213, a mail receiving processing unit 221, and an application executing unit 222.

The file managing unit 211, the power-supply process controller 212, and the internal timer 213 are functions realized when an OS 210 is executed, for example. The file managing unit 211 manages files stored in various storage media connected to the PC 200. Furthermore, the file managing unit 211 has a function of controlling a process of copying a file. For example, the file managing unit 211 receives the copied file 101 from the PC 100 and stores the file 101 in a predetermined region in an HDD 201. Furthermore, as described below, when the portable storage medium 110 is inserted into the PC 200, the file managing unit 211 manages the file stored in the portable storage medium 110. Furthermore, the file managing unit 211 controls a process of copying the file 101 from the portable storage medium 110 to another storage medium such as the HDD 201.

When the PC 200 is powered, the power-supply process controller 212 causes an application program registered in a program list 212a to be automatically executed. The program list 212a is stored in a nonvolatile storage medium such as the HDD 201.

The internal timer 213 counts a date and time. Furthermore, a date and time counted by the internal timer 213 may be updated in accordance with a user's operation, for example. When the date and time is updated, a date and time immediately after the update is recorded in a log 213a, for example. The log 213a is stored in the nonvolatile storage medium such as the HDD 201.

The mail receiving processing unit 221 is a function realized when an application program for transmitting and receiving an electronic mail is executed. The mail receiving processing unit 221 receives an electronic mail supplied from the transmitter PC 100 through a mail server or the like and the network 400. The received electronic mail is stored in the HDD 201. When the file 101 has been attached to the electronic mail, the file 101 is also stored in the HDD 201.

The application executing unit 222 is a function realized when a predetermined application program corresponding to the supplied file 101 is executed. The application executing unit 222 reads and processes the supplied file 101. The application executing unit 222 displays information based on content of the file 101, for example, in a monitor connected to the PC 200.

Here, the file 101 copied by the transmitter PC 100 through the processing procedure described above is stored in the HDD 201 through the process performed by the file managing unit 211. Furthermore, the file 101 which has been attached to the electronic mail and transmitted from the PC 100 through the processing procedure described above is stored in the HDD 201 through the process performed by the mail receiving processing unit 221. When the data deleting program 102 added to the file 101 is executed by the CPU of the PC 200, functions of an activation processing unit 241, an internal timer monitoring unit 242, a date-and-time obtaining unit 243, a period determining unit 244, a deletion processing unit 245, and an application monitoring unit 246 shown in FIG. 8 are realized.

The activation processing unit 241 executes an initial process when the data deleting program 102 is executed. For example, when the data deleting program 102 is first executed, the activation processing unit 241 registers a program name of the data deleting program 102 in the program list 212a. By this, when the PC 200 is shut down, and thereafter, the PC 200 is rebooted, the data deleting program 102 is automatically executed.

The internal timer monitoring unit 242 refers to information on the log 213a and determines whether the internal timer 213 has been updated in accordance with a user's operation.

The date-and-time obtaining unit 243 obtains a current date and time from the internal timer 213.

The period determining unit 244 determines whether the preset period n has been elapsed after the file 101 is supplied from the PC 100.

The deletion processing unit 245 performs a data deleting process on the file 101 in accordance with a request supplied from the internal timer monitoring unit 242 or the period determining unit 244. In the data deleting process, bit data of the file 101 is replaced by a value “0”, for example.

The application monitoring unit 246 monitors operation of the application executing unit 222 and determines whether a performance of a process of opening and closing the file 101 has been requested in accordance with a user's operation. Furthermore, the application monitoring unit 246 prohibits the application executing unit 222 from performing a process of reading the file 101 and temporarily stops the operation of the application executing unit 222 where appropriate.

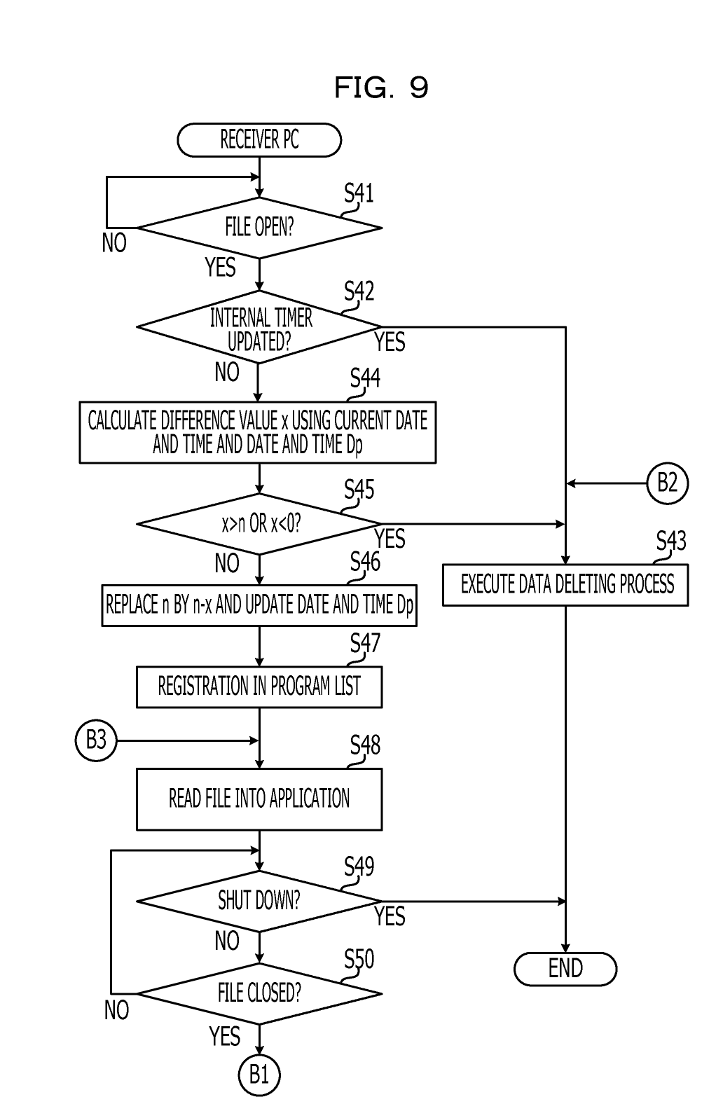

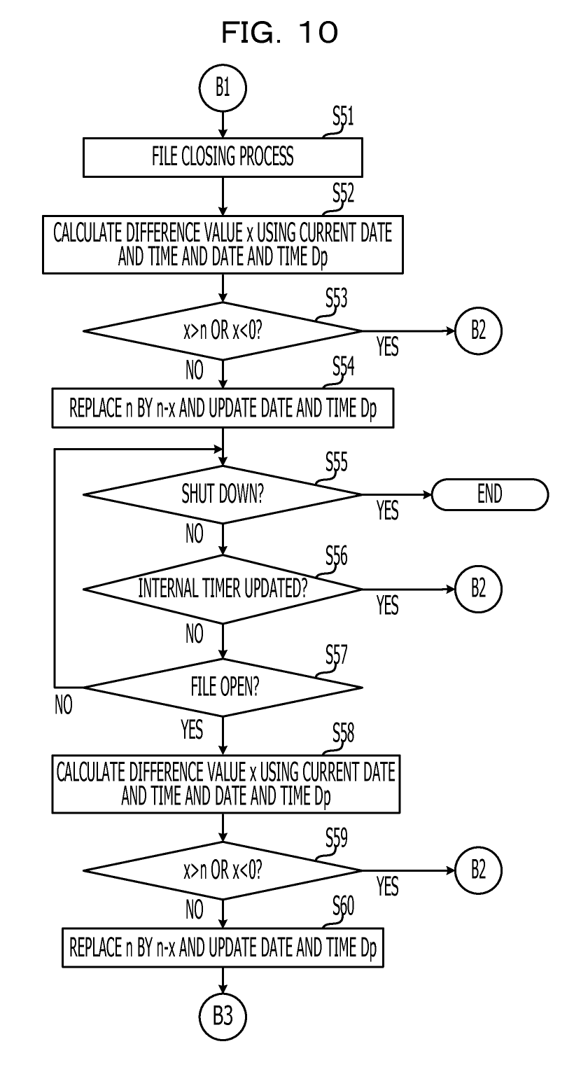

FIGS. 9 and 10 are flowcharts illustrating a procedure of a process performed by the receiver PC 200 when the data deleting program included in the file 101 supplied through the network 400 is first executed.

In operation S41, when a request for opening the file 101 stored in the HDD 201 is supplied in accordance with a user's operation, first, the data deleting program 102 included in the file 101 is executed by the CPU of the PC 200. By this, the functions of the activation processing unit 241, the internal timer monitoring unit 242, the date-and-time obtaining unit 243, the period determining unit 244, the deletion processing unit 245, and the application monitoring unit 246 are realized.

In operation S42, the internal timer monitoring unit 242 determines whether the internal timer 213 has been updated in response to a user's operation. In this process, the following process is performed, for example. The internal timer monitoring unit 242 requests the date-and-time obtaining unit 243 to obtain a current date and time. The date-and-time obtaining unit 243 obtains the current date and time from the internal timer 213 and notifies the internal timer monitoring unit 242 of the current date and time. The internal timer monitoring unit 242 reads information included in the log 213a and a date and time Dp which has been embedded in the data deleting program 102. Then, the internal timer monitoring unit 242 determines whether the internal timer 213 has been updated in response to a user's operation within a period of time from the date and time Dp to the current date and time in accordance with the log 213a.

When the determination is affirmative, the internal timer monitoring unit 242 requests the deletion processing unit 245 to perform the deleting process, and executes a process in operation S43. On the other hand, when the determination is negative, a process in operation S44 is executed.

In operation S43, the deletion processing unit 245 executes a process of deleting date of the file 101. When the data deleting process is terminated, the execution of the data deleting program 102 is terminated.

In operation S44, the period determining unit 244 requests the date-and-time obtaining unit 243 to obtain a current date and time. The date-and-time obtaining unit 243 obtains the current date and time from the internal timer 213 and notifies the period determining unit 244 of the current date and time. The period determining unit 244 subtracts the date and time Dp embedded in the data deleting program 102 from the notified current date and time so as to obtain a difference value x.

In operation S45, the period determining unit 244 determines whether the calculated difference value x is larger than the period of time n embedded in the data deleting program 102 or whether the difference value x is smaller than 0.

When the difference value x is equal to or larger than 0 and equal to or smaller than the period of time n, a time point when the data is to be deleted has not been reached. Then, a process in operation S46 is performed. On the other hand, when the difference value x is larger than the period of time n, or the difference value x is smaller than 0, the period determining unit 244 requests the deletion processing unit 245 to perform the deleting process. By this, the process in operation S43 is executed, that is, the process of deleting the data in the file 101 is executed, and the execution of the data deleting program 102 is terminated.

In operation S46, the period determining unit 244 subtracts the difference value x calculated in operation S44 from the period of time n embedded in the data deleting program 102 so as to update the value of the period of time n. Furthermore, the period determining unit 244 updates the date and time Dp embedded in the data deleting program 102 to the current date and time obtained in operation S44. The updated period of time n and the updated date and time Dp are stored in the HDD 201 along with the program code of the data deleting program 102.

In operation S47, the period determining unit 244 requests the activation processing unit 241 to perform a registering process. The activation processing unit 241 registers the program name of the data deleting program 102 in the program list 212a. After the registration is completed, information on the completion of the registration is transmitted to the application monitoring unit 246.

In operation S48, the application monitoring unit 246 permits the application executing unit 222 to read the file 101. By this, the file 101 is normally opened by the application executing unit 222.

In operation S49, when a shut-down of the PC 200 is requested in accordance with a user's operation, the execution of the data deleting program 102 is terminated under control of the OS 210, and thereafter, the PC 200 is shut down. When the shut-down of the PC 200 is not requested, a process in operation S50 is executed.

In operation S50, the application monitoring unit 246 determines whether the application executing unit 222 has received a request for performing a process of closing the file 101 in accordance with a user's operation, for example. When the determination is affirmative, information on the request is transmitted to the period determining unit 244, and a process in operation S51 is performed. On the other hand, when the determination is negative, the process in operation S49 is performed.

In operation S51, the application executing unit 222 terminates the process performed on the file 101, and the file 101 is closed.

Processes in operation S52 to operation S54 are the same as those in operation S44 to operation S46. That is, the period determining unit 244 subtracts the date and time Dp from a current date and time obtained from the internal timer 213 so as to obtain a difference value x in operation S52. When the difference value x is equal to or larger than 0 and equal to or smaller than the period of time n in operation S53, the period of time n and the date and time Dp are updated in operation S54. Thereafter, the process in operation S55 is performed. On the other hand, when the difference value x is larger than the period of time n or when the difference value x is smaller than 0 in operation S53, the process of deleting the data of the file 101 performed by the deletion processing unit 245 is executed in operation S43.

In operation S55, when the shut-down of the PC 200 is requested in accordance with a user's operation, for example, the execution of the data deleting program 102 is terminated under control of the OS 210. Thereafter, the PC 200 is shut down. When the shut-down of the PC 200 is not requested, a process in operation S56 is performed.

In operation S56, as with the procedure of the process in operation S42, the internal timer monitoring unit 242 determines whether the internal timer 213 has been updated in response to a user's operation. When the determination is affirmative, the internal timer monitoring unit 242 requests the deletion processing unit 245 to perform a deleting process, and the process in operation S43 is performed. On the other hand, when the determination is negative, a process in operation S57 is performed.

In operation S57, the application monitoring unit 246 determines whether the application executing unit 222 is requested to perform a process of opening the file 101 in accordance with a user's operation. When the determination is affirmative, information on the request is transmitted to the period determining unit 244 and a process in operation S58 is performed. On the other hand, when the determination is negative, the process in operation S55 is performed. In this case, the processes in operation S55 to operation S57 are repeatedly performed in a predetermined cycle, for example.

Processes in operation S58 to operation S60 are the same as those in operation S44 to operation S46. That is, the period determining unit 244 subtracts the date and time Dp from a current date and time obtained from the internal timer 213 so as to obtain a difference value x in operation S58. When the difference value x is equal to or larger than 0 and equal to or smaller than the period of time n in operation S59, the period of time n and the date and time Dp are updated in operation S60. In this case, the process in operation S48 is executed so that the file 101 is read by the application executing unit 222 and opened. On the other hand, when the difference value x is larger than the period of time n or when the difference value x is smaller than 0 in operation S59, the deletion processing unit 245 performs the process of deleting the data in the file 101 in operation S43.

In the forgoing process, when the file 101 is requested to be opened in operation S41, the data deleting program 102 added to the file 101 is executed so that the determination as to whether the file 101 is expired in operation S44 and operation S45. When the determination is affirmative, the process of deleting the data in the file 101 is immediately performed in operation S43. Furthermore, since the determination as to whether the internal timer 213 has been illegally falsified is made in operation S42 before the validity determination, the process of determining the validity is more accurately performed and security of the file 101 is enhanced.

Furthermore, after the file 101 is normally opened and thereafter the file 101 is closed, the data deleting program 102 is continuously executed. Thereafter, when the file 101 is requested to be opened again in operation S57, it is determined whether the file 101 is expired in operation S58 and operation S59. When the file 101 is expired, the process of deleting the data in the file 101 is performed in operation S43. Furthermore, since by the time when the request for opening the file 101 is transmitted, the determination as to whether the internal timer 213 has been illegally falsified is made in operation S56, the process of determining the invalidity is accurately performed, and the security of the file 101 is enhanced.

Furthermore, in the receiver apparatus, only by performing the data deleting program 102 or 103 supplied by being added to the file 101, the effect described above is obtained irrespective of a specification and a state of an apparatus serving as a transmission destination of the file 101. For example, the receiver apparatus does not require a presetting such as an execution of a program for obtaining the effect described above.

Furthermore, since the process of deleting the data in the file 101 is performed after a predetermined period of time irrespective of the specification and the state of the transmission destination apparatus, the following effect is also attained. For example, even when an illegal access to the transmitter PC 100 is performed and the file 101 is read by another apparatus, the data deleting program 102 is executed in the apparatus which read the file 101. Accordingly, a period of time in which the file 101 can be normally utilized is limited, and disadvantage caused by leakage of the file 101 can be reduced.

Note that, when the data deleting program 102 is first executed, the program name of the data deleting program 102 is registered in the program list 212a in operation S47. By this, when the PC 200 is shut down in operation S55, and thereafter, the PC 200 is rebooted, the data deleting program 102 is automatically executed. A procedure of a process performed by the PC 200 in this case will be described hereinafter.

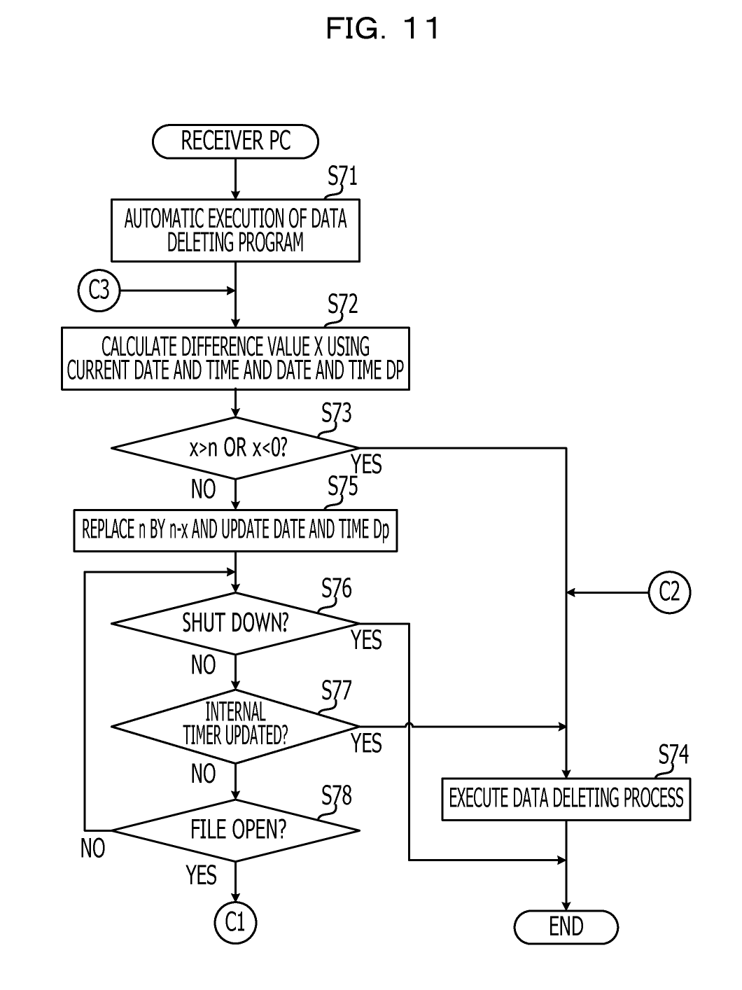

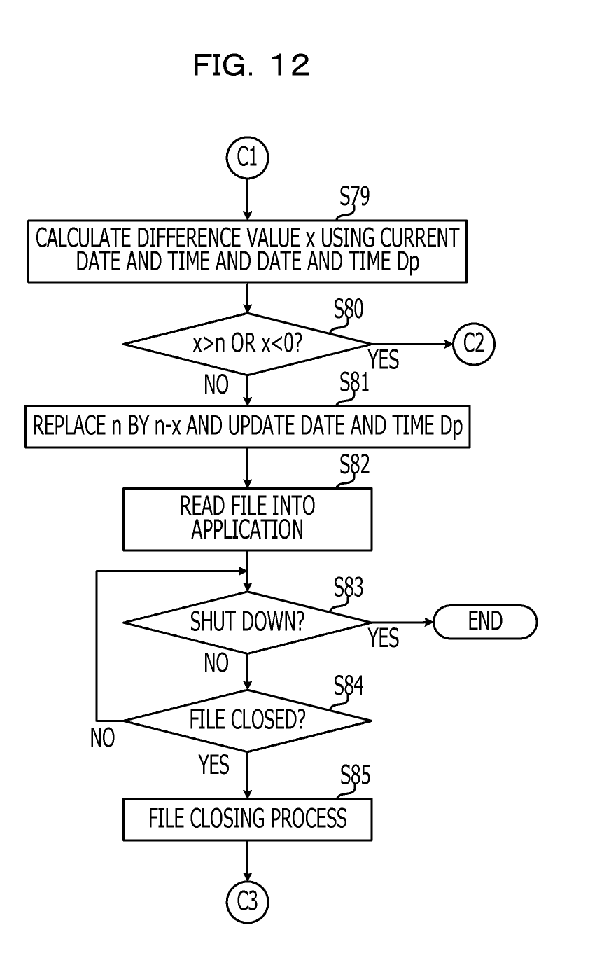

FIGS. 11 and 12 are flowcharts illustrating a procedure of a process performed by the receiver PC 200 when the data deleting program is executed after the PC 200 is rebooted.

In operation S71, when the PC 200 is powered and the OS 210 is activated, the power-supply process controller 212 causes the CPU of the PC 200 to execute a program registered in the program list 212a. By this, the data deleting program 102 is executed and the functions of the internal timer monitoring unit 242, the date-and-time obtaining unit 243, the period determining unit 244, the deletion processing unit 245, and the application monitoring unit 246 are realized.

In operation S72, the period determining unit 244 subtracts the date and time Dp embedded in the data deleting program 102 from a current date and time obtained from the internal timer 213 so as to obtain a difference value x. This processing procedure is the same as that in operation S44.

In operation S73, the period determining unit 244 determines whether the calculated difference value x is larger than the period of time n embedded in the data deleting program 102 or whether the difference value x is smaller than 0. This processing procedure is the same as that in operation S45.

When the difference value x is equal to or larger than 0 and equal to or smaller than the period of time n, a process in operation S75 is performed. On the other hand, when the difference value x is larger than the period of time n or the difference value x is smaller than 0, the period determining unit 244 requests the deletion processing unit 245 to perform the data deleting process. Then, a process in operation S74 is performed.

In operation S74, the deletion processing unit 245 performs the process of deleting the data in the file 101, and thereafter, the execution of the data deleting program 102 is terminated. This processing procedure is the same as that in operation S43 described above.

In operation S75, the period determining unit 244 subtracts the difference value x obtained in operation S72 from the period of time n embedded in the data deleting program 102 so as to update the value of the period of time n. Furthermore, the period determining unit 244 updates the date and time Dp embedded in the data deleting program 102 to the current date and time obtained in operation S72. This processing procedure is the same as that in operation S46 described above.

In operation S76, when the shut-down of the PC 200 is requested in accordance with a user's operation, the execution of the data deleting program 102 is terminated under control of the OS 210. Thereafter, the PC 200 is shut down. When the shut-down of the PC 200 is not requested, a process in operation S77 is performed.

In operation S77, the internal timer monitoring unit 242 determines whether the internal timer 213 has been updated in response to a user's operation. This processing procedure is the same as that in operation S42 described above.

When the determination is affirmative, the internal timer monitoring unit 242 requests the deletion processing unit 245 to perform the deleting process, and the process in operation S74 is performed. On the other hand, when the determination is negative, a process in operation S78 is performed.

In operation S78, the application monitoring unit 246 determines whether the application executing unit 222 is requested to perform a process of opening the file 101 in accordance with a user's operation, for example. When the determination is affirmative, information on the request is transmitted to the period determining unit 244, and a process in operation S79 is performed. On the other hand, when the determination is negative, the process in operation S76 is performed. In this case, the processes in operation S76 to operation S78 are repeatedly performed in a predetermined cycle.

Processes in operation S79 to operation S81 are the same as those in operation S72 to operation S75. That is, the period determining unit 244 subtracts the date and time Dp from a current date and time obtained from the internal timer 213 so as to calculate a difference value x in operation S79. When the difference value x is equal to or lager than 0 and equal to or smaller than the period of time n in operation S80, the period of time n and the date and time Dp are updated in operation S81. In this case, a process in operation S82 is performed. On the other hand, when the difference value x is larger than the period of time n or smaller than 0 in operation S80, the deletion processing unit 245 performs the process of deleting the data in the file 101 in operation S74.

In operation S82, the application monitoring unit 246 permits the application executing unit 222 to read the file 101. By this, the application executing unit 222 normally opens the file 101.

In operation S83, when the shut-down of the PC 200 is requested by a user's operation, for example, the execution of the data deleting program 102 is terminated under control of the OS 210, and thereafter, the PC 200 is shut down. When the shut-down of the PC 200 is not requested, a process in operation S84 is performed.

In operation S84, the application monitoring unit 246 determines whether the application executing unit 222 is requested for performing a process of closing the file 101 in accordance with a user's operation, for example. When the determination is affirmative, information on the request is transmitted to the period determining unit 244, and a process in operation S85 is performed. On the other hand, when the determination is negative, the process in operation S83 is performed.

In operation S85, the application executing unit 222 terminates the process performed on the file 101 and the file 101 is closed. Thereafter, the process in operation S72 is performed again.

As described above, after being activated once, the data deleting program 102 is kept in an on-state and an expiration date of the file 101 corresponding to the data deleting program 102 is kept monitoring. When the expiration date has been reached, the process of deleting the data in the file 101 is reliably performed. Accordingly, the security of the file 101 is enhanced.

Next, a function and a process of the PC 200 performed when the file 101 is supplied to the PC 200 by installing the portable storage medium 110 in which the file 101 has been copied by the PC 100 to the PC 200 will be described.

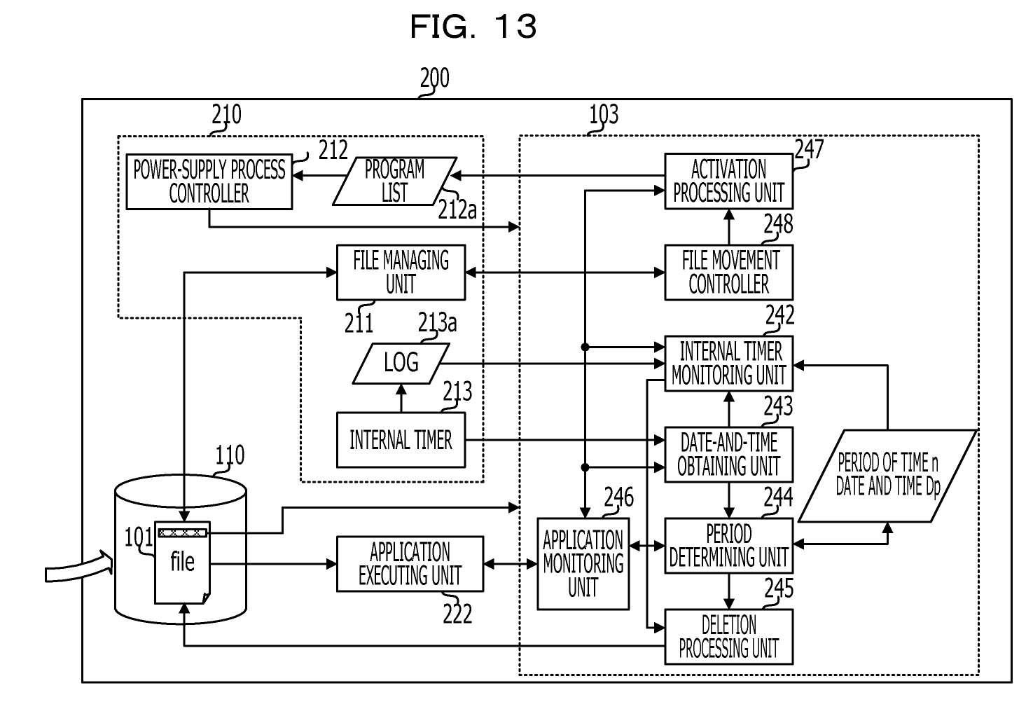

FIG. 13 is a block diagram illustrating functions of the receiver PC 200 when the file 101 is supplied through the portable storage medium 110. Note that, in FIG. 13, components having functions the same as those of the components shown in FIG. 8 are denoted by reference numerals the same as those shown in FIG. 8.

As shown in FIG. 8, the PC 200 includes the file managing unit 211, the power-supply process controller 212, the internal timer 213, the mail receiving processing unit 221, and the application executing unit 222. Note that, in FIG. 13, the mail receiving processing unit 221 is omitted, since the mail receiving processing unit 221 does not relate to the function in this case. When the portable storage medium 110 is inserted into the PC 200, the file managing unit 211 manages a file stored in the portable storage medium 110 and controls a process of copying the file to another storage medium such as the HDD 201.

It is assumed that the data deleting program 103 described above has been added to the file 101 stored in the portable storage medium 110. When the data deleting program 103 is executed by the CPU of the PC 200, functions of the internal timer monitoring unit 242, the date-and-time obtaining unit 243, the period determining unit 244, the deletion processing unit 245, the application monitoring unit 246, an activation processing unit 247, and a file movement controller 248 are realized.

The internal timer monitoring unit 242, the date-and-time obtaining unit 243, the period determining unit 244, the deletion processing unit 245, and the application monitoring unit 246 have the functions the same as the corresponding function blocks shown in FIG. 8.

The activation processing unit 247 basically has a function the same as that of the activation processing unit 241 shown in FIG. 8. However, a timing when a program name is registered in the program list 212a is different from that of the activation processing unit 241.

The file movement controller 248 monitors operation of the file managing unit 211, and determines whether a performance of a process of moving the file 101 from the portable storage medium 110 to another storage medium is allowable when the process is requested. When the determination is affirmative, the file movement controller 248 requests the file managing unit 211 to delete the original file 101 stored in the portable storage medium 110.

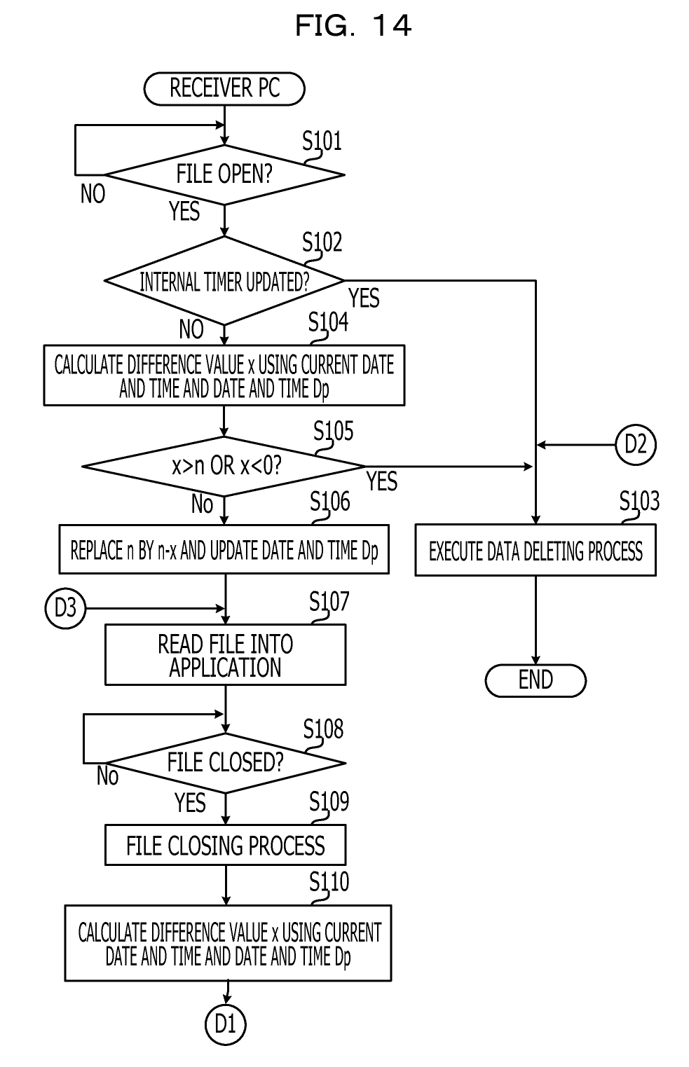

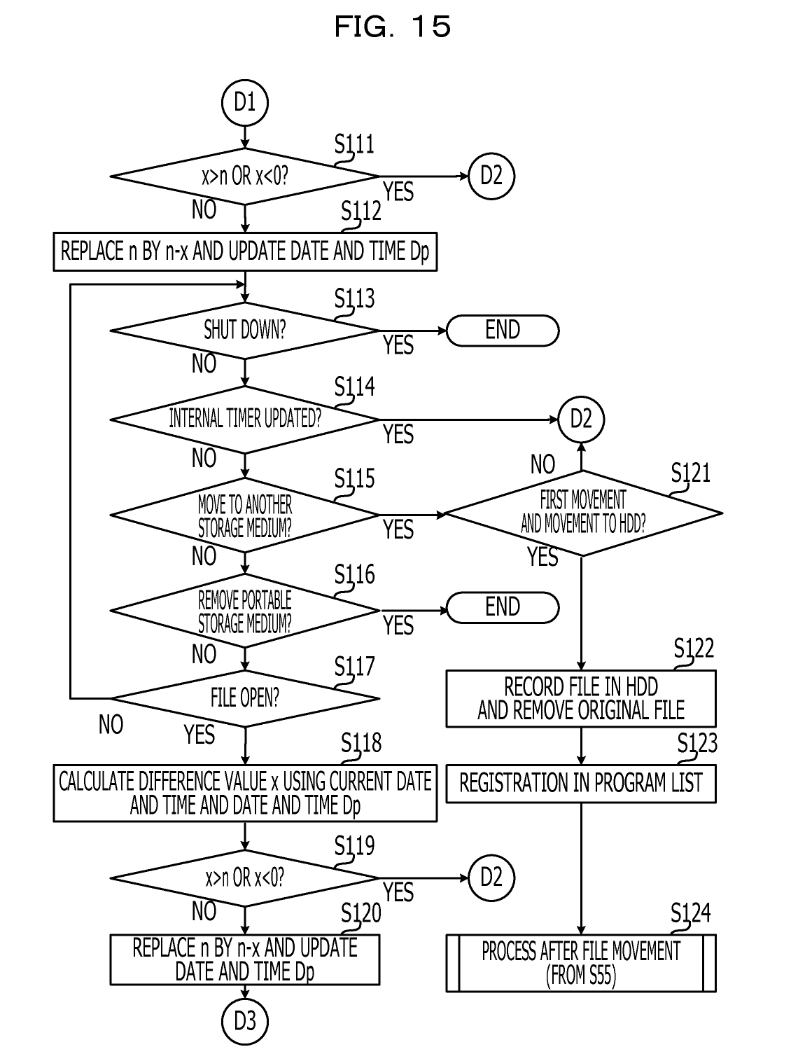

FIGS. 14 and 15 are flowcharts illustrating a procedure of a process performed by the receiver PC 200 when the data deleting program 103 included in the file 101 supplied through the portable storage medium 110 is first executed.

In operation S101, when the file 101 stored in the portable storage medium 110 is requested to be opened by a user's operation or the like, first, the data deleting program 103 included in the file 101 is executed by the CPU of the PC 200. By this, the functions of the activation processing unit 247, the internal timer monitoring unit 242, the date-and-time obtaining unit 243, the period determining unit 244, the deletion processing unit 245, the application monitoring unit 246, and the file movement controller 248 are realized.

In operation S102, the internal timer monitoring unit 242 determines whether the internal timer 213 has been updated in accordance with a user's operation. This processing procedure is the same as that in operation S42 described above.

When the internal timer 213 has been updated, the internal timer monitoring unit 242 requests the deletion processing unit 245 to perform a deleting process and a process in operation S103 is performed. On the other hand, when the internal timer 213 has not been updated, a process in operation S104 is performed.

In operation S103, the deletion processing unit 245 performs the process of deleting the data in the file 101, and thereafter, the execution of the data deleting program 103 is terminated.

In operation S104, the period determining unit 244 requests the date-and-time obtaining unit 243 to obtain a current date and time. The date-and-time obtaining unit 243 obtains the current date and time from the internal timer 213 and notifies the period determining unit 244 of the current date and time. The period determining unit 244 subtracts the date and time Dp embedded in the data deleting program 103 from the current date and time obtained from the internal timer 213 so as to obtain a difference value x. This processing procedure is the same as that in operation S44 described above.

In operation S105, the period determining unit 244 determines whether the obtained difference value x is larger than the period of time n embedded in the data deleting program 103 or smaller than 0. This processing procedure is the same as that in operation S45 described above.

When the difference value x is equal to or larger than 0 and equal to or smaller than the period of time n, a process in operation S106 is performed. On the other hand, when the difference value x is larger than the period of time n or smaller than 0, the period determining unit 244 requests the deletion processing unit 245 to perform the data deleting process. Then, the process in operation S103 is performed.

In operation S106, the period determining unit 244 subtracts the difference value x obtained in operation S104 from the period of time n embedded in the data deleting program 103 so as to update the value of the period of time n. Furthermore, the period determining unit 244 updates the date and time Dp embedded in the data deleting program 103 to the current date and time obtained in operation S104. These processing procedures are the same as those in operation S46 described above.

In operation S107, the application monitoring unit 246 permits the application executing unit 222 to read the file 101. Then, the application executing unit 222 normally opens the file 101.

In operation S108, the application monitoring unit 246 determines whether the application executing unit 222 is requested to close the file 101 in accordance with a user's operation or the like. When the determination is affirmative, information on the request is transmitted to the period determining unit 244, and a process in operation S109 is performed. On the other hand, when the determination is negative, the process in operation S108 is repeatedly performed.

In operation S109, the application executing unit 222 terminates the process performed on the file 101, and the file 101 is closed.

Processes in operation S110 to operation S112 are the same as those in operation S104 to operation S106. That is, the period determining unit 244 subtracts the date and time Dp from the current date and time obtained from the internal timer 213 so as to obtain a difference value x in operation S110. When the difference value x is equal to or larger than 0 and equal to or smaller than the period of time n in operation S111, the period of time n and the date and time Dp are updated in operation S112. On the other hand, when the difference value x is larger than the period of time n or smaller than 0 in operation S111, the deletion processing unit 245 performs the process of deleting the data in the file 101 in operation S103.

In operation S113, when the shut-down of the PC 200 is requested by a user's operation or the like, the execution of the data deleting program 103 is terminated under control of the OS 210. Thereafter, the PC 200 is shut down. When the shut-down of the PC 200 is not requested, a process in operation S114 is performed.

In operation S114, the internal timer monitoring unit 242 determines whether the internal timer 213 has been updated by a user's operation. This processing procedure is the same as that in operation S102 described above.

When the determination is affirmative, the internal timer monitoring unit 242 requests the deletion processing unit 245 to perform the deleting process and the process in operation S103 is performed. On the other hand, when the determination is negative, a process in operation S115 is performed.

In operation S115, the file movement controller 248 determines whether the file managing unit 211 has been requested to perform the process of moving the file 101 included in the portable storage medium 110 to another storage medium. When the determination is affirmative, a process in operation S121 is performed whereas when the determination is negative, a process in operation S116 is performed.

In operation S116, when the portable storage medium 110 is removed from the PC 200, the execution of the data deleting program 103 is terminated. When the portable storage medium 110 is not removed from the PC 200, a process in operation S117 is performed.

In operation S117, the application monitoring unit 246 determines whether the application executing unit 222 has been requested to perform the process of opening the file 101. When the determination is affirmative, information on the request is transmitted to the period determining unit 244 and a process in operation S118 is performed. On the other hand, when the determination is negative, the process in operation S113 is performed. In this case, the processes in operation S113 to operation S117 are repeatedly performed in a predetermined cycle.

Processes in operation S118 to operation S120 are the same as those in operation S104 to operation S106. That is, the period determining unit 244 subtracts the date and time Dp from a current date and time obtained from the internal timer 213 so as to obtain a difference value x in operation S118. When the difference value x is equal to or larger than 0 and equal to or smaller than the period of time n in operation S119, the period of time n and the date and time Dp are updated in operation S120. Thereafter, the process in operation S107 is performed. On the other hand, when the difference value x is larger than the period of time n or smaller than 0 in operation S119, the deletion processing unit 245 performs the process of deleting the data in the file 101 in operation S103.

In operation S121, when the process of moving the file 101 is requested, the file movement controller 248 determines whether the moving process is performed for the first time and whether a moving destination is a fixed storage medium which has been predetermined. Here, as an example of the storage medium, the HDD 201 included in the PC 200 is employed. When the conditions described above are satisfied, a process in operation S122 is performed. On the other hand, when the conditions described above are not satisfied, the process in operation S103 is performed, that is, the process of deleting the data in the file 101 is performed.

Note that, a movement of the file 101 included in the portable storage medium 110 to the HDD 201 is permitted only once, and at the time of the movement, the file 101 is removed from the portable storage medium 110. Therefore, if the movement process is requested several times, the requests are determined to be illegal. Furthermore, a request for moving the file 101 to a destination other than the HDD 201 is also determined to be illegal. Therefore, when the conditions described above are not satisfied, the file 101 is not normally used.

In operation S122, the file movement controller 248 permits the file managing unit 211 to move the file 101 and requests the file managing unit 211 to remove the original file 101 stored in the portable storage medium 110. The file managing unit 211 records the file 101 to which the data deleting program 103 has been added in a predetermined region in the HDD 201, and removes the original file 101 from the portable storage medium 110.

In operation S123, the file movement controller 248 notifies the activation processing unit 247 of the movement of the file 101 to the HDD 201. The activation processing unit 247 registers a program name of the data deleting program 103 added to the moved file 101 in the program list 212a in response to the notification.

In operation S124, a processing procedure performed in the PC 200 after the file 101 is moved to the HDD 201 is the same as that performed from operation S55 in the processing procedure shown in FIGS. 9 and 10. Therefore, a description of the processing procedure is omitted. That is, the process starting from operation S55 is performed by the internal timer monitoring unit 242, the date-and-time obtaining unit 243, the period determining unit 244, the deletion processing unit 245, and the application monitoring unit 246 which are realized by executing the data deleting program 103.

Furthermore, when the PC 200 is shut down in operation S49 and operation S55, and thereafter, the PC 200 is rebooted, the PC 200 performs the process shown in FIGS. 11 and 12. In this case, in operation S71, the data deleting program 103 added to the file 101 which has been moved to the HDD 201 is automatically executed. By this, the internal timer monitoring unit 242, the date-and-time obtaining unit 243, the period determining unit 244, the deletion processing unit 245, and the application monitoring unit 246 are realized, and the process starting from operation S72 is performed.

As described above, in the case where the file 101 is supplied through the portable storage medium 110, when the file 101 is requested to be opened in operation S101, the data deleting program 103 added to the file 101 is executed and it is determined whether the file 101 is expired in operation S104 and operation S105. When the determination is affirmative, the process of deleting the data in the file 101 is immediately performed in operation S103. Furthermore, since the determination as to whether the internal timer 213 is illegally falsified in operation S102 before the determination as to whether the file 101 is expired is made, the determination as to whether the file 101 is expired is reliably performed, and the security of the file 101 is enhanced.

Even after the file 101 is normally opened, and thereafter, the file 101 is closed, the data deleting program 103 is continuously executed. When the file 101 is requested to be opened in operation S117, it is determined whether the file 101 is expired in operation S118 and operation S119. When the determination is affirmative, the process of deleting the data in the file 101 is performed in operation S103. Furthermore, before the file 101 is requested to be opened, it is determined whether the internal timer 213 has been illegally falsified in operation S114. Accordingly, the process of determining expiration is more reliably performed and the security of the file 101 is enhanced.

Furthermore, the file 101 recorded in the portable storage medium 110 can be moved only once to the predetermined fixed storage medium, for example. Accordingly, usability for the user is enhanced. Moreover, even after the file 101 is moved to the fixed storage medium, when the file 101 is expired or when the internal timer 213 is illegally falsified, the data in the file 101 is deleted in accordance with the process of the data deleting program 103. Consequently, the security of the file 101 is maintained.

On the other hand, when the file 101 is supplied through the network 400, a movement of the file 101 from a storage medium which currently stores the file 101 to another storage medium may be prohibited. For example, when a request for moving the file 101 to another storage medium is detected, the data in the file 101 may be deleted even when the file 101 is not expired.

In the process described above, when the portable storage medium 110 which stores the file 101 is removed from the PC 200, the execution of the data deleting program 103 is terminated. However, even after the portable storage medium 110 is removed, the execution of the data deleting program 103 may be continued. In this case, when the portable storage medium 110 which stores the same file 101 is installed again, the determination as to whether the file 101 is expired is made within a short period of time without activating the data deleting program 103 again.

Furthermore, in the second embodiment, the data deleting program 102 or 103 is automatically executed through the process performed by the power-supply process controller 212 in accordance with the program list 212a after the PC 200 is rebooted. However, such an automatic execution function may be realized by another method.

### Third Embodiment

In the second embodiment described above, after the file 101 is transmitted from the PC 100 to the PC 200, the data deleting program 102 or 103 is executed at a timing when the file 101 is opened for the first time. On the other hand, in the third embodiment described hereinafter, when a file 101 is supplied from a PC 200, a data deleting program 102 or 103 is automatically executed.

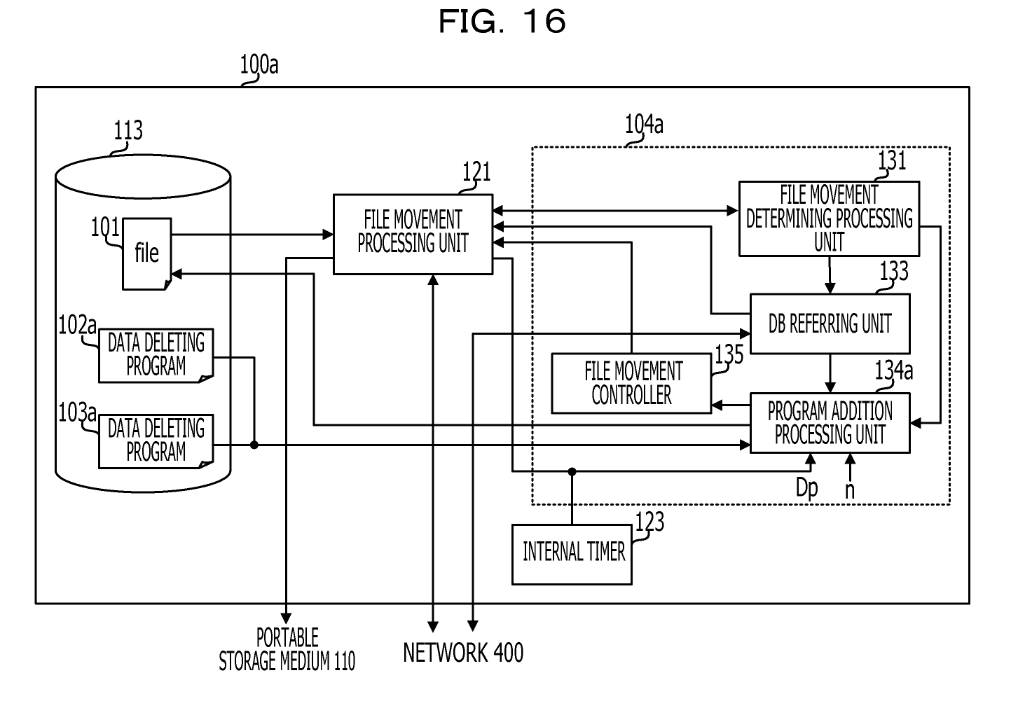

FIG. 16 is a block diagram illustrating functions of a transmitter PC 100a.

The PC 100a shown in FIG. 16 is employed instead of the PC 100 of the second embodiment. Furthermore, in FIG. 16, components having functions the same as the functions of the components shown in FIG. 4 are denoted by reference numerals the same as those of the components shown in FIG. 4. Note that the PC 100a is realized by a hardware configuration the same as that shown in FIG. 3.

As with the second embodiment, the PC 100a includes a file movement processing unit 121 and an internal timer 123. The file movement processing unit 121 performs a process of copying the file 101 recorded in a HDD 113 in response to an user's operation input to the PC 100a or a request received through a network 400 from an external apparatus such as a PC 200a described below. The internal timer 123 counts a date and time. Functions of the file movement processing unit 121 and the internal timer 123 are realized when an OS is executed.

Furthermore, the PC 100a includes a file movement determining processing unit 131, a program addition processing unit 134a, a DB referring unit 133, and a file movement controller 135 as functions realized when a data management program 104a is executed. Note that the file movement determining processing unit 131 and the DB referring unit 133 include functions the same as the processing blocks corresponding to the file movement determining processing unit 131 and the DB referring unit 133 of the second embodiment.

The program addition processing unit 134a basically includes a function the same as the function of the program addition processing unit 134 shown in FIG. 4. However, a procedure of a process after performing a process of adding a program to the file 101 is different. Furthermore, the program addition processing unit 134a adds a data deleting program 102a or 103a stored in the HDD 113 to the file 101. As with the data deleting programs 102 and 103, the data deleting programs 102a and 103a are used to delete data included in the file 101 after a predetermined period of time has been elapsed. However, content described in the data deleting programs 102a and 103a is different from content described in the data deleting programs 102 and 103 in some points.

The file movement controller 135 transmits information used to automatically execute a program to the file movement processing unit 121 along with the file 101 after the program addition processing unit 134a performs the process of adding the program. Note that, for example, the function of the file movement processing unit 121 may be integrated with the function of the file movement controller 135 and realized when the data management program 104a is executed.

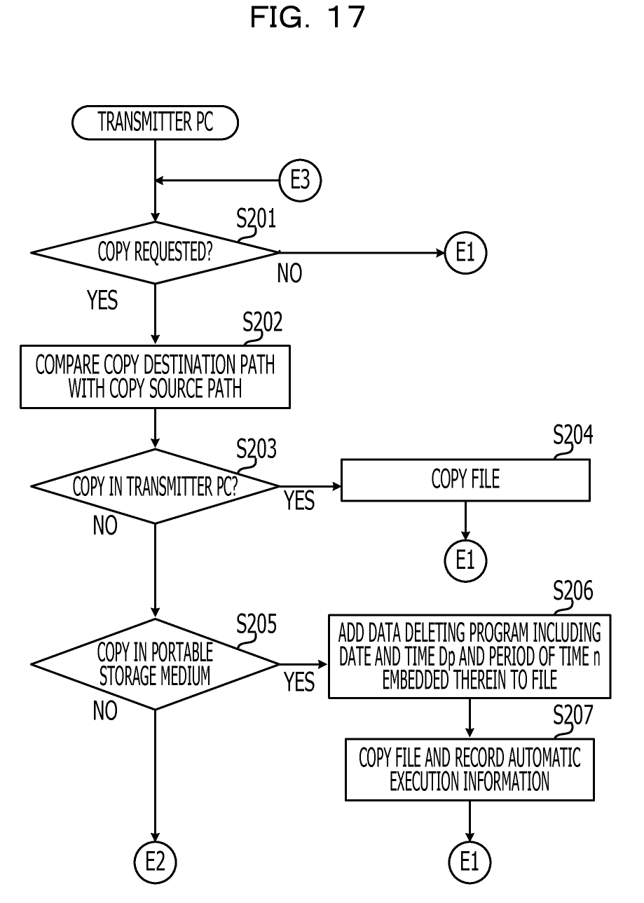

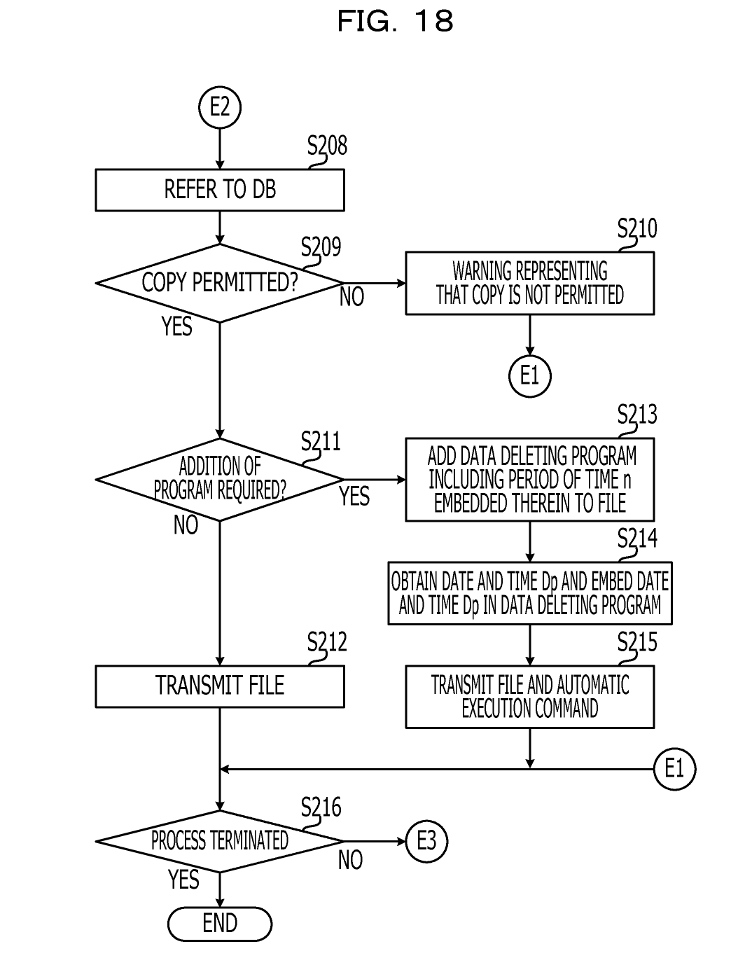

FIGS. 17 and 18 are flowcharts illustrating a procedure of a process performed by the transmitter PC 100a when a copy of data is requested.

In operation S201, the file movement determining processing unit 131 monitors operation of the file movement processing unit 121 and determines whether a copy of the file 101 was requested by a user's operation input to the PC 100a or an operation request supplied from a receiver PC. When the determination is affirmative, a process in operation S202 is performed whereas when the determination is negative, a process in operation S216 is performed.

Processes in operation S202 to operation S204 are the same as those in operation S13 to operation S15, respectively, shown in FIG. 6. That is, the file movement determining processing unit 131 obtains a path of a copy destination of the file 101 requested to be copied and a path of a copy source from the file movement processing unit 121 and compares the paths with each other in operation S202. As a result of the comparison, when it is determined that the copy destination of the file 101 is included in a storage region in the PC 100a in operation S203, the file 101 is copied in a requested position included in the storage region in operation S204. On the other hand, when it is determined that the copy destination is not included in the storage region in the PC 100a in operation S203, a process in operation S205 is performed.

In operation S205, the file movement determining processing unit 131 determines whether a copy to a portable storage medium 110 has been requested in accordance with a result of the comparison of the paths performed in operation S202. When the determination is affirmative, a process in operation S206 is performed. On the other hand, when the determination is negative, a process in operation S208 is performed.

In operation S206, the file movement determining processing unit 131 notifies the program addition processing unit 134a of the request for the copy to the portable storage medium 110. The program addition processing unit 134a obtains a current date and time Dp from the internal timer 123. Furthermore, the program addition processing unit 134a reads the data deleting program 103a for a portable storage medium from the HDD 113 and embeds the date and time Dp and a preset period of time n in the data deleting program 103a. Then, the program addition processing unit 134a adds the data deleting program 103a to the file 101. Note that, for example, the data deleting program 103a is embedded in a header region of the file 101.

In operation S207, the program addition processing unit 134a notifies the file movement controller 135 of completion of the addition of the program. The file movement controller 135 permits the file movement processing unit 121 to copy the file 101 and to perform a copy process. In this case, the file movement controller 135 records automatic execution information used to automatically execute the data deleting program 103a in an apparatus serving as a transmission destination in the portable storage medium 110 along with the file 101. The automatic execution information corresponds to a data file including a name of a program to be automatically executed, for example, and in this case, a program name of the data deleting program 103a is included in the automatic execution information.

Thereafter, a process in operation S216 is executed.

Note that, when the copy of the file 101 to the portable storage medium 110 is to be executed, information included in a database 301 may be referred to using the DB referring unit 133. When a file name of the file 101 has been registered as an undeleted file name 314 in the database 301, the addition of the data deleting program 103a and the recording of the automatic execution information may not be performed.

Processes in operation S208 to operation S210 are the same as those in operation S19 to operation S21, respectively, shown in FIG. 6. That is, the file movement determining processing unit 131 determines that a copy to the external apparatus connected to the network 400 is requested and requests the DB referring unit 133 to refer to the database 301. The DB referring unit 133 accesses the DB server 300 in response to the request and refers to the database 301 in operation S208. Then, the DB referring unit 133 determines whether a copy of the file 101 to an apparatus serving as a copy destination has been permitted in operation S209. When the determination is affirmative, a process in operation S211 is performed. On the other hand, when the determination is negative, the copy process is terminated, and information representing that the copy is not permitted is supplied to a user who requested the copy through a monitor, for example, in operation S210. Thereafter, a process in operation S216 is performed.

A process in operation S211 is the same as that in operation S22 shown in FIG. 7. That is, the DB referring unit 133 determines whether the data deleting program 102a is to be added to the file 101 in accordance with information registered in the database 301. When the determination is affirmative, a process in operation S213 is performed whereas when the determination is negative, a process in operation S212 is performed.

In operation S212, the DB referring unit 133 permits the file movement processing unit 121 to copy the file 101. The file movement processing unit 121 reads the file 101 from the HDD 113 and transmits the file 101 to the requested copy destination apparatus. Thereafter, a process in operation S216 is performed.

In operation S213, the DB referring unit 133 notifies the program addition processing unit 134a of a request for copying the file 101 to another apparatus through the network 400. The program addition processing unit 134a reads the data deleting program 102a for network transmission from the HDD 113 and embeds the preset period of time n in the data deleting program 102a. Then, the program addition processing unit 134a adds the data deleting program 102a to the file 101. Note that the data deleting program 102a is embedded in the header region of the file 101, for example.

In operation S214, the program addition processing unit 134a notifies the file movement controller 135 of an end of the process of adding a program. The file movement controller 135 permits the file movement processing unit 121 to copy the file 101 and a copy process is performed by the file movement processing unit 121.

In this case, the program addition processing unit 134a obtains a current date and time Dp counted by the copy destination apparatus and embeds the current date and time Dp in the data deleting program 102a which has been added to the file 101. The date and time Dp is obtained from time information described in a packet transmitted from the copy destination apparatus when the file movement processing unit 121 communicates with the copy destination apparatus for the copy of the file 101, for example.

In operation S215, the file movement controller 135 controls the copy process performed by the file movement processing unit 121, and transmits the file 101 to which the data deleting program 102a has been added to the copy destination apparatus. Then, the file movement controller 135 transmits automatic execution information used to automatically execute the data deleting program 102a in the copy destination apparatus to the copy destination apparatus. The automatic execution information corresponds to a control command used to request an automatic execution, for example. The file movement controller 135 notifies the copy destination apparatus of a completion of the data transmission after the automatic execution information is transmitted. Thereafter, the process in operation S216 is performed.

In operation S216, if an end of the execution of the data management program 104a has not been requested in accordance with a user's operation or the like, the process in operation S201 is performed again.

According to the processes shown in FIGS. 17 and 18, when a copy of the file 101 to the external apparatus or the portable storage medium 110 is requested, the data deleting program 102a or 103a is basically added to the file 101. Furthermore, the automatic execution information is also supplied to the receiver apparatus along with the file 101. As will be described below, the copy destination apparatus which received the automatic execution information automatically executes the data deleting program 102a or 103a which has been added to the file 101. By this, data included in the copied file 101 can be deleted from the receiver apparatus after a predetermined period of time has been elapsed, and security of the file 101 is enhanced.

Furthermore, as with the second embodiment, the user can arbitrarily set a destination to which the file 101 is prohibited from being transmitted and a destination in which the file 101 is not requested to be automatically deleted or a name of a file not to be deleted.

Next, a processing function of the receiver PC 200a and operation of the PC 200a will be described. Here, a case where the file 101 is supplied through the network 400 and a case where the file 101 is supplied through the portable storage medium 110 will be separately described.

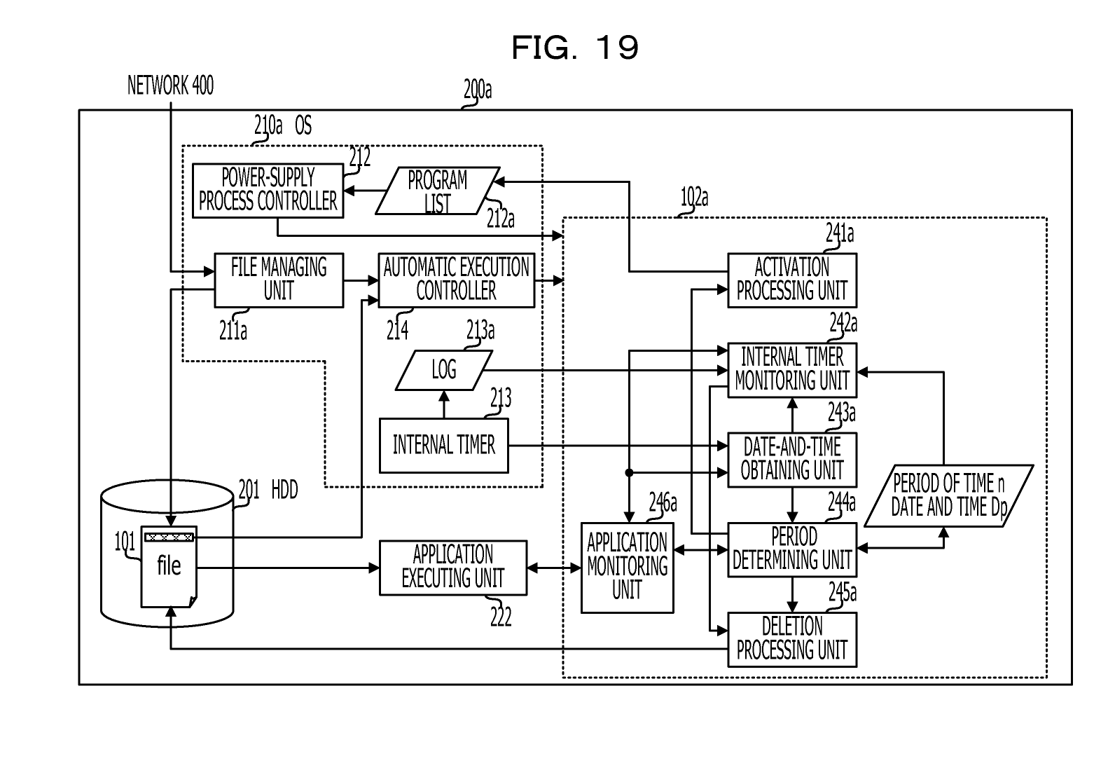

FIG. 19 is a block diagram illustrating functions of the receiver PC 200a when the file 101 is copied through the network 400.

The PC 200a shown in FIG. 19 is employed instead of the PC 200 of the second embodiment. Furthermore, in FIG. 19, components having functions the same as functions of the components shown in FIG. 8 are denoted by reference numerals the same as those shown in FIG. 8. Note that the PC 200a is realized by a hardware configuration the same as that shown in FIG. 3.

As with the second embodiment, the PC 200a includes a power-supply process controller 212 and an internal timer 213. Functions of the power-supply process controller 212 and the internal timer 213 are realized when an OS 210a is executed. Furthermore, the PC 200a further includes a file managing unit 211a and an automatic execution controller 214 as functions realized when the OS 210a is executed.

A function of the file managing unit 211a is basically the same as that of the file managing unit 211 shown in FIG. 8. However, the file managing unit 211a further has a function of obtaining automatic execution information and transmitting the obtained automatic execution information to the automatic execution controller 214 when the file 101 is supplied from the transmitter PC 100a or when the portable storage medium 110 which stores the file 101 is installed as described below.

The automatic execution controller 214 causes a CPU to automatically execute the data deleting program 102a or 103a which has been added to the file 101 in accordance with the automatic execution information supplied from the file managing unit 211a. This function of the automatic execution controller 214 is realized when the OS 210a is executed for example, and this function is implemented in general OSs.

Furthermore, as with the second embodiment, the PC 200a includes an application executing unit 222. The application executing unit 222 is a function realized when a predetermined application program corresponding to the supplied file 101 is executed. The application executing unit 222 reads the supplied file 101 and performs processing on the file 101.

In the PC 200a, when the file 101 is supplied through the network 400, the file 101 is stored in a HDD 201 through a process performed by the file managing unit 211a. In this case, when the data deleting program 102a has been added to the file 101 through the process described above, the data deleting program 102a is executed by the CPU of the PC 200a under control of the automatic execution controller 214. By this execution, functions of an activation processing unit 241a, an internal timer monitoring unit 242a, a date-and-time obtaining unit 243a, a period determining unit 244a, a deletion processing unit 245a, and an application monitoring unit 246a are realized.

The functions of the activation processing unit 241a, the internal timer monitoring unit 242a, the date-and-time obtaining unit 243a, the period determining unit 244a, the deletion processing unit 245a, and the application monitoring unit 246a are basically the same as the functions of the activation processing unit 241, the internal timer monitoring unit 242, the date-and-time obtaining unit 243, the period determining unit 244, the deletion processing unit 245, and the application monitoring unit 246, respectively, shown in FIG. 8. However, timings when the individual functions are activated are different.

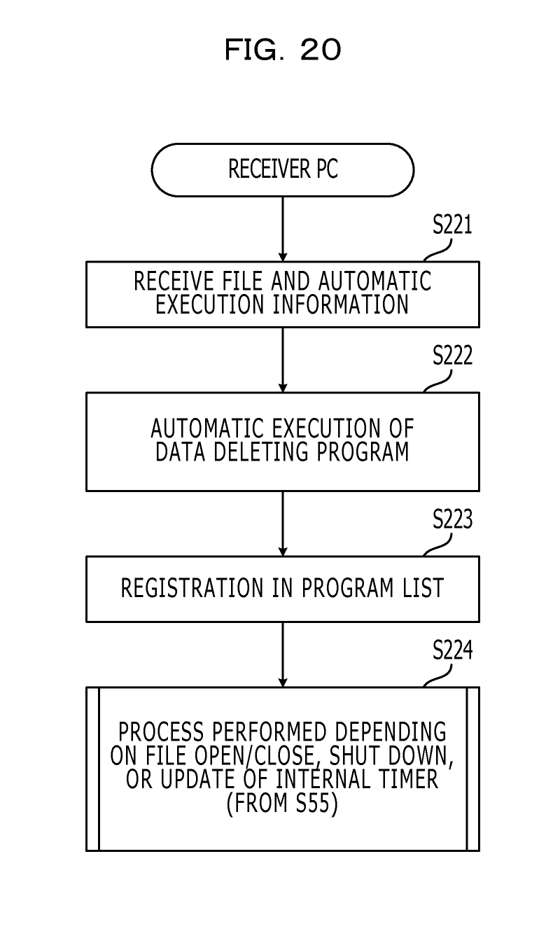

FIG. 20 is a flowchart illustrating a procedure of an initial process performed by the receiver PC 200a when the file 101 is copied through the network 400.

In operation S221, the file managing unit 211a receives the file 101 transmitted from the PC 100a and stores the file 101 in the HDD 201. Furthermore, the file managing unit 211a receives the automatic execution information supplied from the PC 100a and transmits the information to the automatic execution controller 214.

In operation S222, the automatic execution controller 214 causes the CPU of the PC 200a to execute the data deleting program 102a added to the file 101 in accordance with the transmitted automatic execution information. By this, the data deleting program 102a is automatically executed, and the functions of the activation processing unit 241a, the internal timer monitoring unit 242a, the date-and-time obtaining unit 243a, the period determining unit 244a, the deletion processing unit 245a, and the application monitoring unit 246a are realized. Note that, as described above, a control command for requesting an execution of the data deleting program 102a may be used as the automatic execution information.

In operation S223, a program name of the data deleting program 102a is registered in the program list 212a.

Thereafter, in operation S224, the processes starting from operation S55 in the processing procedure shown in FIGS. 9 and 10 are performed. That is, these processes are performed by the internal timer monitoring unit 242a, the date-and-time obtaining unit 243a, the period determining unit 244a, the deletion processing unit 245a, and the application monitoring unit 246a shown in FIG. 19 instead of the internal timer monitoring unit 242, the date-and-time obtaining unit 243, the period determining unit 244, the deletion processing unit 245, and the application monitoring unit 246 shown in FIG. 8.

Furthermore, when the PC 200a is shut down in operation S49 and operation S55, and thereafter, the PC 200a is rebooted, the processes shown in FIGS. 11 and 12 are performed by the PC 200a. In this case, in operation S71, the data deleting program 102a added to the file 101 which has been moved to the HDD 201 is automatically executed. By this, the internal timer monitoring unit 242a, the date-and-time obtaining unit 243a, the period determining unit 244a, the deletion processing unit 245a, and the application monitoring unit 246a shown in FIG. 19 are realized, and the processes in operation S72 onwards are performed.

In the foregoing processes, when the file 101 is copied in the PC 200a, the data deleting program 102a which has been added to the file 101 is immediately executed irrespective of whether the file 101 is requested to be opened. By this, for example, if the internal timer 213 is illegally falsified before the file 101 is requested to be opened, a process of deleting the data in the file 101 is performed. Furthermore, in a case where the PC 200a is shut down before the file 101 is opened, and thereafter, the PC 200a is rebooted, the data deleting program 102a is automatically executed.

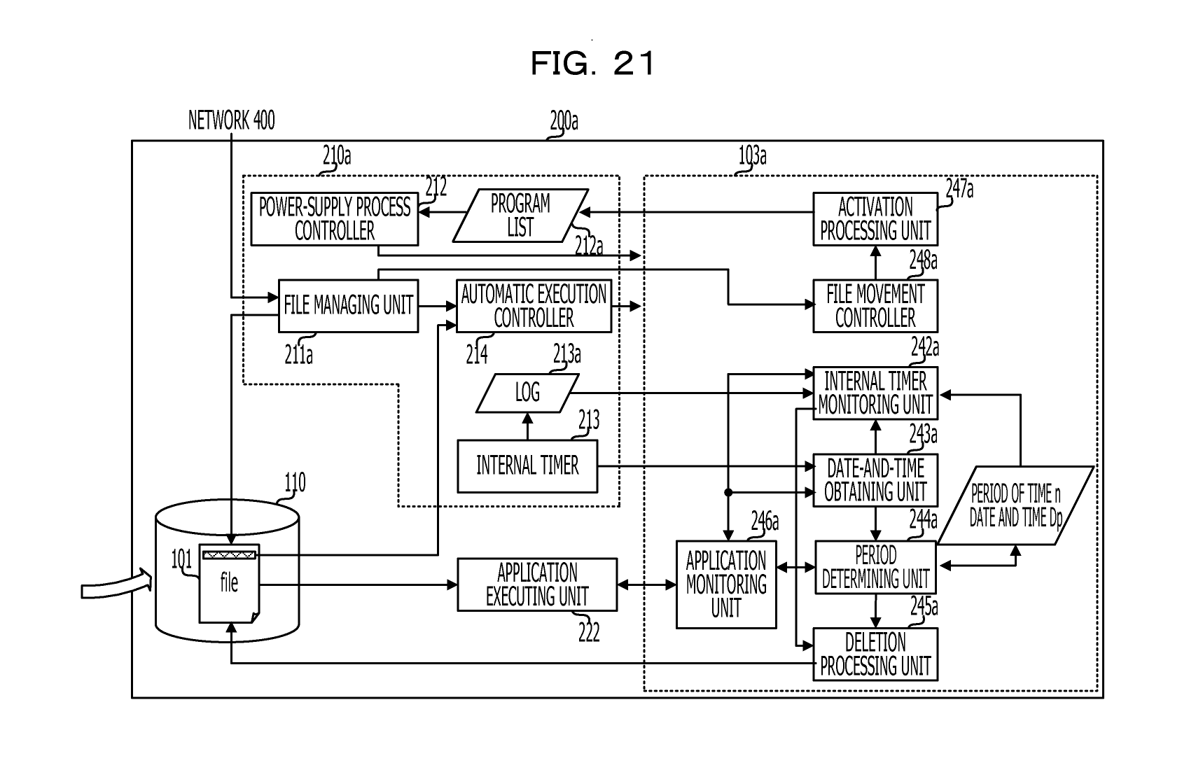

FIG. 21 is a block diagram illustrating functions of the receiver PC 200a when the file 101 is supplied through the portable storage medium 110. Note that, in FIG. 21, components the same as those having functions the same as those of the components shown in FIG. 19 are denoted by reference numerals the same as shown in FIG. 19.

As shown in FIG. 21, the PC 200a includes the file managing unit 211a, the power-supply process controller 212, the internal timer 213, the automatic execution controller 214, and the application executing unit 222. Furthermore, when the portable storage medium 110 is installed in the PC 200a, the file managing unit 211a manages the file 101 stored in the portable storage medium 110 and performs a process of copying the file 101 to another storage medium such as the HDD 201.

Furthermore, when the portable storage medium 110 which stores automatic execution information is installed in the PC 200a, the file managing unit 211a reads the information and transmits the information to the automatic execution controller 214. Here, the automatic execution controller 214 causes the CPU of the PC 200a to execute the data deleting program 103a added to the file 101 included in the portable storage medium 110.

When the data deleting program 103a is executed, functions of the internal timer monitoring unit 242a, the date-and-time obtaining unit 243a, the period determining unit 244a, the deletion processing unit 245a, the application monitoring unit 246a, an activation processing unit 247a, and a file movement controller 248a are realized. Note that, although the activation processing unit 247a basically has the function the same as that of the activation processing unit 247 shown in FIG. 13, an operation timing thereof is different.

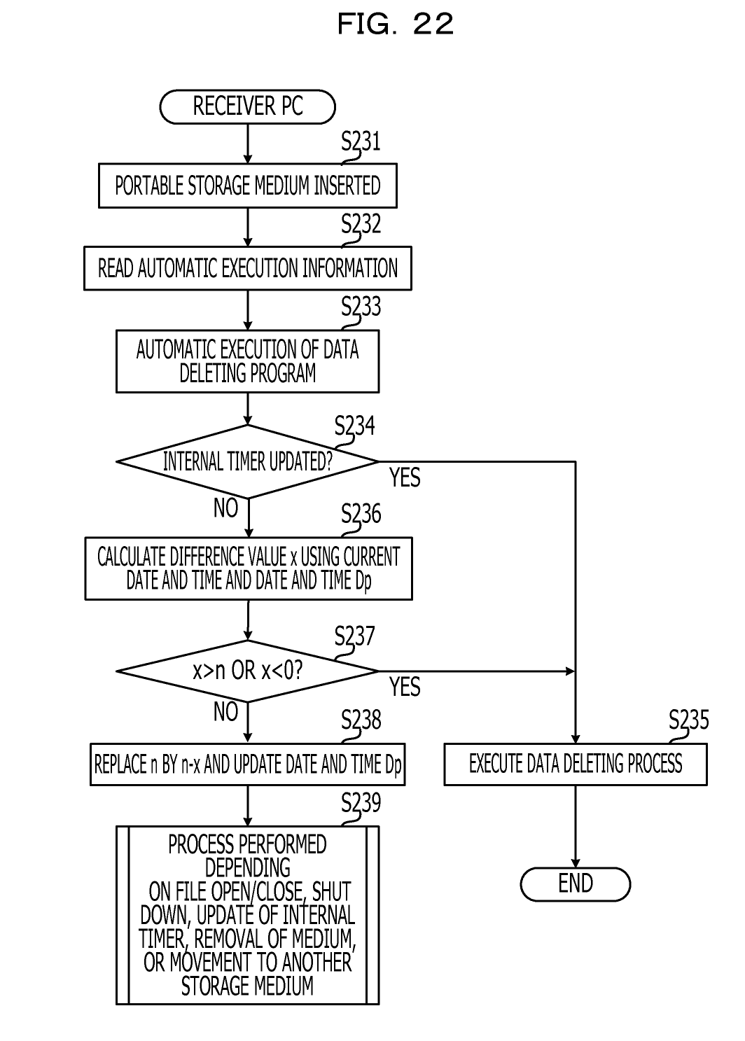

FIG. 22 is a flowchart illustrating a procedure of an initial process performed by the receiver PC 200a when the file 101 is supplied through the portable storage medium 110.

In operation S231, when detecting the portable storage medium 110 installed in the PC 200a, the file managing unit 211a performs a process of recognizing data stored in the portable storage medium 110.

In operation S232, when the automatic execution information has been stored in the portable storage medium 110, the file managing unit 211a reads the information and transmits the information to the automatic execution controller 214.

In operation S233, the automatic execution controller 214 causes the CPU of the PC 200a to execute the data deleting program 103a which has been added to the file 101 in accordance with the supplied automatic execution information. By this, the data deleting program 103a is automatically executed and the functions of the internal timer monitoring unit 242a, the date-and-time obtaining unit 243a, the period determining unit 244a, the deletion processing unit 245a, the application monitoring unit 246a, the activation processing unit 247a, and the file movement controller 248a are realized.

Note that, as described above, as the automatic execution information, for example, a data file including a name of a program to be automatically executed described therein may be employed. In this case, when detecting the program name of the data deleting program 103a, the automatic execution controller 214 reads and executes the data deleting program 103a.

In operation S234, the internal timer monitoring unit 242a determines whether the internal timer 213 has been updated in accordance with a user's operation. This processing procedure is the same as that in operation S42.

When the determination is affirmative, the internal timer monitoring unit 242a requests the deletion processing unit 245a to perform the deleting process, and a process in operation S235 is performed. On the other hand, when the determination is negative, a process in operation S236 is performed.

In operation S235, the deletion processing unit 245a deletes the data included in the file 101. After the process is terminated, the execution of the data deleting program 103a is terminated.

In operation S236, the period determining unit 244a requests the date-and-time obtaining unit 243a to obtain a current date and time, and the date-and-time obtaining unit 243a obtains the current date and time from the internal timer 213 and transmits the current date and time to the period determining unit 244a. The period determining unit 244a subtracts the date and time Dp embedded in the data deleting program 103a from the current date and time obtained from the internal timer 213 so as to obtain a difference value x. This processing procedure is the same as that in operation S44.

In operation S237, the period determining unit 244a determines whether the obtained difference value x is larger than the period of time n embedded in the data deleting program 103a or smaller than 0. This processing procedure is the same as that in operation S45 described above.

When the difference value x is equal to or larger than 0 and equal to or smaller than the period of time n, a process in operation S238 is performed. On the other hand, when the difference value x is larger than the period of time n or when the difference value x is smaller than 0, the period determining unit 244a requests the deletion processing unit 245a to perform the data deleting process. Then the process in operation S235 is performed.

In operation S238, the period determining unit 244a subtracts the difference value x calculated in operation S236 from the period of time n embedded in the data deleting program 103a and updates a value of the period of time n. Furthermore, the period determining unit 244a updates the date and time Dp embedded in the data deleting program 103a to the current date and time obtained in operation S236. This processing procedure is the same as that in operation S46.

Thereafter, in operation S239, in the processing procedure shown in FIGS. 14 and 15, the processes starting from operation S113 is performed. That is, these processes are executed by the internal timer monitoring unit 242a, the date-and-time obtaining unit 243a, the period determining unit 244a, the deletion processing unit 245a, and the application monitoring unit 246a shown in FIG. 21 instead of the internal timer monitoring unit 242, the date-and-time obtaining unit 243, the period determining unit 244, the deletion processing unit 245, and the application monitoring unit 246 shown in FIG. 8.

In the foregoing processes, when the portable storage medium 110 which stores the file 101 installed in the PC 200a, the data deleting program 103a added to the file 101 is immediately executed irrespective of whether the file 101 is requested to be opened. By this, for example, even before the file 101 is requested to be opened, the process of deleting the data included in the file 101 is performed only when the file 101 is expired. Furthermore, even before the file 101 is requested to be opened, when the internal timer 213 is illegally falsified, the process of deleting the data included in the file 101 is performed.

Note that, the functions included in the apparatus (for example, the information processing apparatuses 10 and 30 and the PCs 100, 100a, 200, and 200a) can be realized by a computer. In this case, a program including the processes of the functions described therein is supplied to the computer. When the computer executes the program, the processing functions described above are realized in the computer. The program including the processes described therein may be recorded in a computer readable recording medium. Examples of the computer readable recording medium include a magnetic recording medium, an optical disc, a magneto-optical recording medium, and a semiconductor memory.

When the program is to be distributed, a portable recording media such as optical discs including the program recorded therein are sold. Alternatively, the program may be stored in a storage device included in a server computer and the program may be transmitted from the server computer through a network to another computer.

The computer which executes a program stores a program stored in a portable recording medium or a program transmitted from a server computer in a storage device of the computer. Then, the computer reads the program from the storage device of itself and performs a process in accordance with the program. Note that the computer may directly read the program from the portable recording medium so as to perform a process in accordance with the program. Furthermore, every time a program is transmitted from the server computer, the computer may perform a process in accordance with the received program.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An information processing apparatus comprising:
a file output detector configured to detect a request for performing a process of outputting a file from a first storage medium; and
a program addition processing unit configured to add a data deleting program to the file to be output when the file output detector detects the request for performing the process of outputting a file, wherein
the data deleting program causes an apparatus which received the file to perform a method, the method including:
determining whether a preset period of time has been elapsed, and
deleting at least part of data of the file when it is determined that the preset period of time has been elapsed.

2. The information processing apparatus according to claim 1 which performs the method, the method further comprising:
determining, when an application executing unit included in the apparatus which received the file is requested to read and process the file for the first time, whether the preset period of time has been elapsed from when the file is received to when the request is transmitted to the application executing unit; and
permitting the read of the file when it is determined that the preset period of time has not been elapsed.

3. The information processing apparatus according to claim 1,
wherein the apparatus which received the file includes
a second storage medium, and
a file reception processing unit which stores the file supplied through a network in the second storage medium.

4. The information processing apparatus according to claim 3, further comprising:
a transmission processing unit configured to transmit the file to which the data deleting program has been added and automatic execution information,
wherein the apparatus which received the file includes a controller which executes the data deleting program in accordance with the received automatic execution information.

5. The information processing apparatus according to claim 3,
wherein the second storage medium is a portable storage medium, and
when the second storage medium is installed in an apparatus, the data deleting program which has been added to the file stored in the second storage medium is executed by the apparatus in which the second storage medium has been installed.

6. The information processing apparatus according to claim 5 which performs the method, the method further comprising:
permitting, when a movement of the file from the second storage medium to a third storage medium included in the apparatus which has received the file is requested, the movement of the file to the third storage medium, and deleting the file included in the second storage medium.

7. The information processing apparatus according to claim 3, further comprising:
a transmission processing unit configured to transmit the file to which the data deleting program has been added and automatic execution information,
wherein the second storage medium is a portable storage medium,
the file reception processing unit stores the file and the automatic execution information transmitted through the network in the second storage medium, and
the data deleting program which has been added to the file is executed, when the second storage medium is installed, by an apparatus in which the second storage medium is installed in accordance with the automatic execution information stored in the second storage medium.

8. The information processing apparatus according to claim 1, further comprising:
an output permission determining unit configured to determine whether a destination to which the file is to be output corresponds to a destination to which the file is permitted to be output,
wherein the program addition processing unit adds the data deleting program to the file when the destination is determined to be the destination to which the file is permitted to be output.

9. The information processing apparatus according to claim 3, further comprising:
an output permission determining unit configured to determine whether the file includes data permitted to be output to the second storage medium,
wherein the program addition processing unit adds the data deleting program to the file when it is determined that the file includes the data permitted to be output to the second storage medium.

10. The information processing apparatus according to claim 1 which performs the method, the method further comprising:
determining whether a time measured by a timer unit included in the apparatus which received the file has been updated in accordance with a user's operation input; and
deleting at least part of data included in the file when it is determined that the time measured by the timer unit has been updated irrespective of whether the preset period of time has been elapsed.

11. The information processing apparatus according to claim 1, further comprising:
a file attachment detector configured to detect a request for performing a process of attaching the file to a text message when the file is to be transmitted through a network in a state in which the file is attached to the text message by a message transmission processing unit,
wherein the program addition processing unit adds the data deleting program to the file when the file attachment detector detects the request for performing the process of attaching the file.

12. The information processing apparatus according to claim 1 which performs the method, the method further comprising:
registering identification information of the data deleting program in a program list,
wherein the apparatus which received the file executes the data deleting program in accordance with the identification information registered in the program list when being activated.

13. An information processing method, the method comprising:
causing a computer to detect a request for performing a process of outputting a file from a storage medium;
causing the computer to add a data deleting program to the file to be output when the request for performing the process of outputting a file is detected,
wherein the data deleting program causes an apparatus which received the file to perform a method including:
determining whether a preset period of time has been elapsed, and
deleting at least part of data of the file when it is determined that the preset period of time has been elapsed.

14. A computer readable recording medium which records an information processing program to be executed by a computer, the information processing program causes the computer to execute a method, the method comprising:
detecting a request for performing a process of outputting a file from a storage medium;
adding a data deleting program to the file to be output when the request for performing the process of outputting a file is detected,
wherein the data deleting program causes an apparatus which received the file to perform a method including:
determining whether a preset period of time has been elapsed, and
deleting at least part of data of the file when it is determined that the preset period of time has been elapsed.
